(19) United States
(12) Patent Application Publication
(10) Pub. No.: US 2002/0111859 A1
(43) Pub. Date: Aug. 15, 2002

(54) Integrated frequency and award redemption program for installment based receivables behavior modification and customer loyalty management

(76) Inventors: Gregory Sheldon, Tacoma, WA (US); Scott Jarol, Seattle, WA (US); Marisa Pena, Seattle, WA (US)

Correspondence Address: WELLS ST. JOHN P.S., 601 W. FIRST, SUITE 1300, SPOKANE, WA, 99201-3828, US

(21) Appl. No.: 09/788,302

(22) Filed: Feb. 15, 2001

(51) Int. Cl. G06F 17/60

(52) U.S. Cl. 705/14; 705/1

(57) ABSTRACT

An integrated automated frequency award program is disclosed. An installment payment transaction processing system forwards the details of a customer's payment to a secondary transaction processing system, which evaluates whether the payment was received on or before the due date. If paid by the due date, the secondary transaction processing system calculates award points based on variable criteria, updates the points account balance for the enrolled customer or Member, and communicates the reward to the Member. Members may browse a catalog of available products and services for which they may redeem their awarded points. When a Member selects a product or service for redemption of his or her points, the system verifies that the Member's points account balance contains sufficient points to purchase the item, then places the order with the appropriate vendor or fulfillment service and subtracts the redeemed points from the Member's account balance.

### TECHNICAL FIELD

The present invention pertains to a loyalty marketing and behavior modification program based on installment and time-delayed payment behavior. The invention integrates automated transaction processing systems with online customer service systems to operate and maintain a loyalty program based on awards, redemption, and multi-channel customer communications.

### BACKGROUND OF THE INVENTION

Frequency programs have been developed by various industries to promote customer loyalty. The most well-known include paper-based programs for purchases made at retail merchants, various frequent flyer programs in which travelers earn points or miles redeemable for travel on the same or affiliated airlines, consumer credit programs in which points redeemable for merchandise or services are earned for each credit line draw, and online programs which reward enrolled members with redeemable points for visiting or making purchases at Internet Web sites.

In mileage programs, travelers earn points, a special reward currency often referred to as “miles,” in exchange for booking and checking in for flights. The amount of the reward often depends on the distance traveled. These “Mileage” programs have begun to recruit companies from other sectors of the travel and hospitality industries to award travel mileage in exchange for hotel room rentals, auto rentals, meal service, and various other services. When a traveler has accumulated a sufficient number of mileage points, he may redeem these points for an award chosen from a specific list of awards specified by the program. Thus, for example, the traveler may redeem the points for a free flight ticket, a discount on hotel accommodations, or a free rental car. In order to redeem the points, the traveler generally needs to a request a certificate, and use the issued certificate as payment for the free travel.

According to another type of frequency and award program, a credit instrument is provided and credit points are accumulated instead of mileage points. In such programs, bonus points are awarded by using a formula in which a price paid for merchandise is a parameter. Thus, upon each purchase a certain number of bonus points are awarded, which translate to a currency credit amount. According to these programs, the customer receives a credit instrument, which may be acceptable by many enrolled retailers, so that the selection of prizes available is enhanced.

A third type of frequency and award program rewards consumers for making purchases from a merchant. Under such a program, an award of redeemable points is calculated by means of a formula in which the price paid for merchandise is a parameter. Points accumulate in the form of either paper certificates, or in the case of online merchants, are automatically accrued in an account established for the purpose. Consumers may browse a catalog of redemption options and place orders for items by redeeming all or some of their accrued points. In the case of paper-based programs, the consumer mails an order form to the merchant or program manager requesting the redemption. In an online program, the consumer may browse an online catalog and select items for redemption electronically.

### BRIEF DESCRIPTION OF THE DRAWINGS

Preferred embodiments of the invention are described below with reference to the accompanying drawings, which are briefly described below.

FIG. 1 is a flow chart depicting one embodiment of an overall process contemplated by the present invention;

FIG. 2 depicts an embodiment showing the relationship of various networked computer systems and databases that may provide the operational platform for the preferred embodiment of the present invention;

FIG. 3 is a flow chart depicting an embodiment of a process by which Members may be enrolled in a program contemplated by the present invention;

FIG. 4 is a flow chart depicting an example of a process that may be used to generate recurring customer account statements;

FIG. 5 is a flow chart depicting one embodiment of a transaction processing portion which may be utilized as part of the present invention;

FIG. 6 is a flow chart depicting one embodiment of how the calculation of awards may be accomplished;

FIG. 7 is a flow chart depicting one embodiment of an online bill payment process which may be utilized as part of this invention;

FIG. 8 is a flow chart depicting one embodiment of a means of online access to the program's online features;

FIG. 9 is a flow chart depicting one example of a process by which Members accessing the program online may select various functions of the program;

FIG. 10 is an exemplary flow chart depicting a process by which newly enrolled Members may activate their accounts;

FIG. 11 is a flow chart depicting one embodiment of a process by which Members may activate individual installment obligations that have been appended to their existing Membership accounts;

FIG. 12 is a flow chart depicting an embodiment of a process by which Members may query the program for the current status of their accounts;

FIG. 13 is a flow chart depicting an embodiment of a process by which registered Members may be authenticated to gain secure access to the online features of the program;

FIG. 14 is a flow chart depicting an embodiment of a process by which registered program Members may browse the program's catalog of redemption products and services, also known as prizes;

FIG. 15 is a flow chart depicting an embodiment of a process by which registered program Members may redeem their rewards points for products listed in the redemption catalog;

FIG. 16 is a screen snapshot of an online electronic bill payment center home page which may be sent in the form of a hypertext document by the Member Access Server Computer to the Member Personal Computer in FIG. 7;

FIG. 17 is a screen snapshot of an online electronic bill payment form which may be utilized to be sent in the form of a hypertext document by the Member Access Server Computer to the Member Personal Computer in FIG. 7;

FIG. 18 is a screen snapshot of an error message document sent in the form of a hypertext document by the Member Access Server Computer to the Member Personal Computer in FIG. 7;

FIG. 19 is a screen snapshot of an embodiment of a document which indicates successful online electronic payment with a subsequent award of points sent in the form of a hypertext document by the Member Access Server Computer to the Member Personal Computer in FIG. 7;

FIG. 20 is a screen snapshot of the main home page of a timely payment rewards program sent in the form of a hypertext document by the Member Access Server Computer to the Member Personal Computer in FIG. 9;

FIG. 21 is a screen snapshot of an embodiment of a new Member account activation instructions document sent in the form of a hypertext document by the Member Access Server Computer to the Member Personal Computer in FIG. 10;

FIG. 22 is a screen snapshot of an embodiment of a Member Login form sent in the form of a hypertext document by the Member Access Server Computer to the Member Personal Computer in FIG. 13;

FIG. 23 is a screen snapshot of an embodiment of a sub-account list document sent in the form of a hypertext document by the Member Access Server Computer to the Member Personal Computer in FIG. 11;

FIG. 24 is a screen snapshot of an embodiment of a sub-account activation form sent in the form of a hypertext document by the Member Access Server Computer to the Member Personal Computer in FIG. 11;

FIG. 25 is a screen snapshot of an embodiment of a sub-account activation error document sent in the form of a hypertext document by the Member Access Server Computer to the Member Personal Computer in FIG. 11;

FIG. 26 is a screen snapshot of an embodiment of a Member account status report document sent in the form of a hypertext document by the Member Access Server Computer to the Member Personal Computer in FIG. 12;

FIG. 27 is a screen snapshot of an embodiment of a Member logout confirmation form sent in the form of a hypertext document by the Member Access Server Computer to the Member Personal Computer in FIG. 13;

FIG. 28 is a screen snapshot of an embodiment of a login error report document sent in the form of a hypertext document by the Member Access Server Computer to the Member Personal Computer in FIG. 13;

FIG. 29 is a screen snapshot of an embodiment of a Member redemption program home page document sent in the form of a hypertext document by the Member Access Server Computer to the Member Personal Computer in FIG. 14;

FIG. 30 is a screen snapshot of an embodiment of a redemption catalog product list document sent in the form of a hypertext document by the Member Access Server Computer to the Member Personal Computer in FIG. 14;

FIG. 31 is a screen snapshot of an embodiment of a redemption product detail document sent in the form of a hypertext document by the Member Access Server Computer to the Member Personal Computer in FIG. 15;

FIG. 32 is a screen snapshot of an alternative view of an embodiment of a redemption product detail document sent in the form of a hypertext document by the Member Access Server Computer to the Member Personal Computer in FIG. 15;

FIG. 33 is a screen snapshot of an embodiment of a redemption order confirmation document sent in the form of a hypertext document by the Member Access Server Computer to the Member Personal Computer in FIG. 15;

FIG. 34 is a screen snapshot of an embodiment of a redemption order error document sent in the form of a hypertext document by the Member Access Server Computer to the Member Personal Computer in FIG. 15;

FIG. 35 is an example of recurring statement of account document printed and sent to a Member in FIG. 4; and

FIG. 36 illustrates three flow charts of embodiments illustrating the processing of payments made and points awarded or accrued.

### DETAILED DESCRIPTION OF THE PREFERRED EMBODIMENTS

Reference will now be made to a preferred embodiment of the Applicants' invention. One exemplary implementation is described below and depicted with reference to the drawings comprising one embodiment of the invention, which may be used on a public network such as the internet. While the invention is described via a preferred embodiment, it is understood that the description is not intended to limit the invention to this embodiment, but is intended to cover equivalents and modifications such as are included within the scope of the appended claims.

Further, due to the nature of the level of skill in the art, there may be, without limitation, various menu items, explanatory text, buttons, menus, routines, subroutines, source code, display configurations which are known or may readily be duplicated by known programming means by one skilled in the art, and they will not therefore be described in significant detail.

While the preferred embodiment is described and used in connection with the internet and the world wide web, the term communications network or public communications network as used herein is meant in its broadest sense to include these and all other current and future communication networks, including public packet switched communications networks, and the current or future internet.

The term memory areas as used herein is intended to cover any area with temporary or permanent memory capabilities, including any memory storage mediums, such as a computer hard drives, disks, data storage devices, and others as set forth below. The databases described below would typically be stored in a memory area.

For purposes of this disclosure, it is understood that memory generally refers to a data storage device resident within or associated with a computer, such as a random access memory (RAM). As utilized herein, memory is intended to refer to any form of storage medium associated with a computer, such as a data storage device, and including hard disk drives (HDDs), semiconductor memories and addressable storage spaces present within a processing unit or other internal storage devices that are used to execute instructions and/or store data and addresses, or any other form of memory as presently understood within the art, or which may later be developed. Furthermore, it is understood that memory can be physically subdivided into units such as a first memory area, a second memory area, and a third memory area. Such units are not necessarily physically associated, but can be associated via the ability to address and/or locate such memory areas.

The typical hardware includes a processor or microprocessor; a hard disk drive; screen displays; input devices such as a keyboard and/or a mouse; and other associate components which are well understood and known in the art.

Additionally, the term computer generally includes hardware such as one or more processors, or microprocessor; one or more data storage devices, such as a hard disk drive (“HDD”); memory, such as random access memory (“RAM”); and an interface device, such as a display, a keyboard and/or a mouse.

The various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

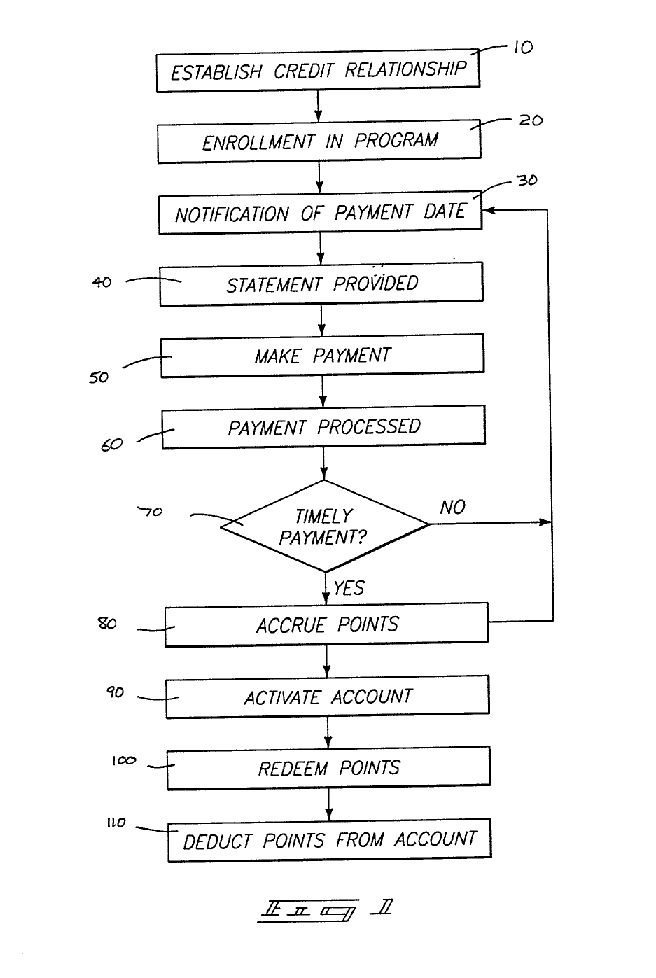

The program according to the present invention will be described with reference to FIGS. 1-36. All numerical identifiers assigned to the drawings or to elements of the drawings have been assigned arbitrarily as unique identifiers and neither imply nor specify any specific sequence of operation.

FIG. 1 is a flowchart outlining the general operation of the preferred embodiment of the program described by the present invention. In FIG. 1, step 10 indicates that an Entity, either in the form of an individual person or in the form of a business entity, establishes a credit relationship with a lender or service provider such as a bank or a public utility company. Hereinafter, a lender or service provider shall be known as a Provider or Creditor. FIG. 1, step 20 indicates that the Creditor enrolls the entity in a program that rewards timely payment. Hereinafter, an enrolled Entity shall be known as a Member of the program, or simply as a Member, and the relationship between a Creditor and a Member shall be known as an Obligation.

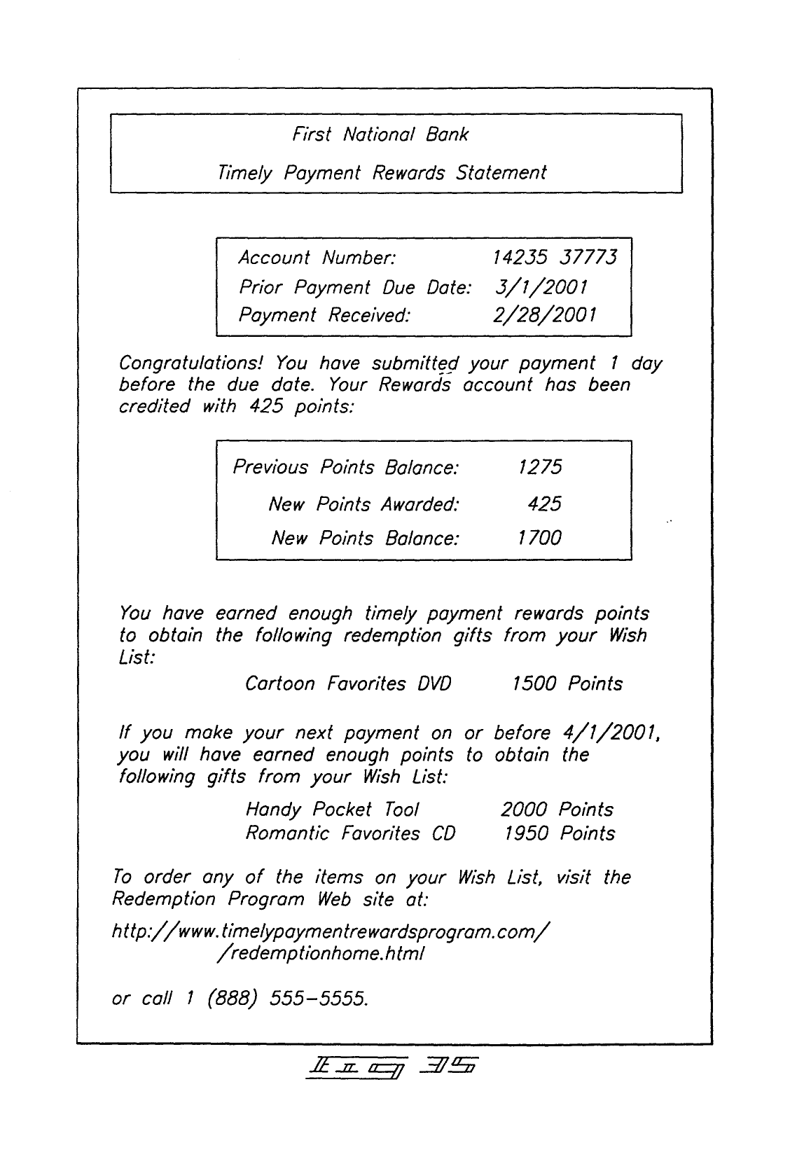

In FIG. 1, at step 30, the Creditor furnishes the Member with a statement or payment coupon specifying the date and amount of the next installment payment due to the Creditor. FIG. 1, at step 40 specifies that the program furnishes the Member with an additional statement, an example of which is illustrated in FIG. 35, indicating the current balance of rewards points earned up to the date on which the statement is issued, and urging the Member to make the next payment on, or prior to the due date in order to earn additional reward points. Rewards points shall be known hereinafter as Points. The statement may also offer the Member additional bonus Points for other desired credit performance behaviors, such as using an electronic payment system, or for making a specific number of successive on-time payments, or for other reasons not yet identified.

In FIG. 1, at step 50, the Member makes a scheduled installment payment to the Creditor, which the Creditor processes in step 60 to properly credit the Member's Obligation account. In step 70, the payment is analyzed to determine whether it was received by the Creditor on or prior to the scheduled due date. If not, the cycle begins again with step 30. If the payment has been received on or before the due date, Points are awarded to the Member, as shown in step 80.

In FIG. 1, at step 90, the Member activates his account by providing credentials issued by the Creditor at the time of enrollment. Event or step 90 may occur at any point in the process after step 20 and before step 100.

FIG. 1, step 100 outlines a process by which a Member may redeem accrued Points for products or services listed in a catalog of such opportunities assembled for the program, known hereinafter as the Redemption Catalog. In step 100, the Member's Points balance is reduced by the number of Points redeemed for any particular item selected from the Redemption Catalog, as reflected in event or step 110.

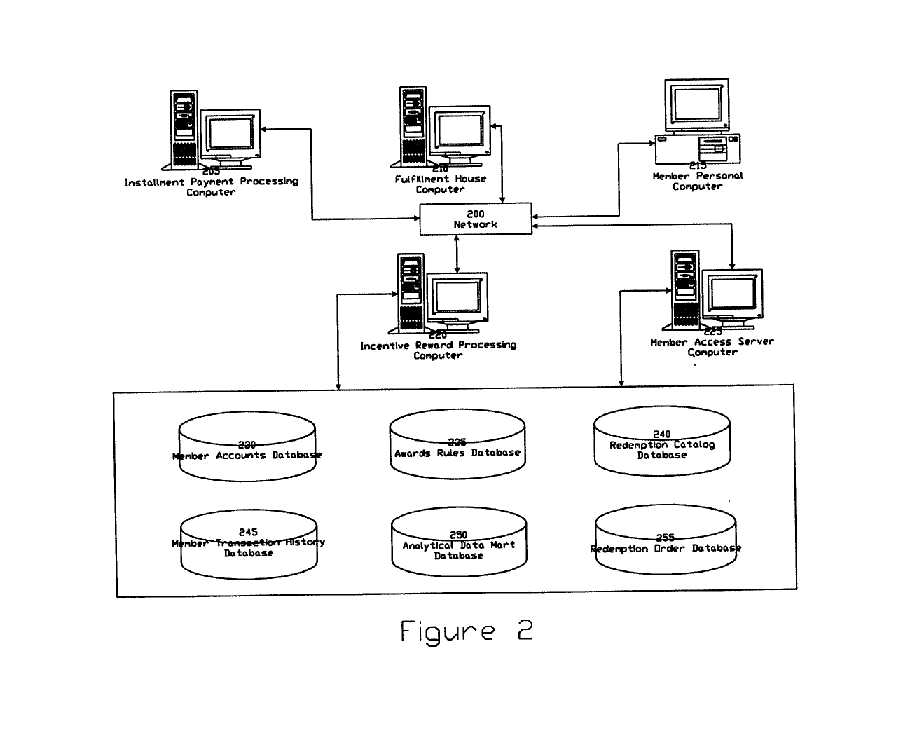

With reference to FIG. 2 a timely payment rewards system in accordance with the present invention may, but need not, include any one or more of the following: an Installment Payment Processing Computer 205 operated by the Creditor accepting scheduled payments; a Member Computer 215 operated by a Member who wishes to make payments or manage his or her Membership account; an Incentive Reward Processing Computer 220 operated by the Creditor or a third-party service Creditor to calculate rewards and update Member accounts; a Member Access Server Computer 225 operated by the Creditor or a third-party service Creditor to communicate with the Member by means of electronic documents such as HTML-based Web pages; and a Fulfillment House Computer 210 operated by the Creditor or by a third-party program service Creditor or by a third-party merchant to process orders placed by the Member from the Redemption Catalog.

All these computers may be connected by a data communications network 200, such as the Internet, by an intranet, or any other type of network. The Incentive Reward Processing Computer 220 and the Member Access Server Computer 225, may share access to any one or more of the following: a Member Accounts Database 230; an Awards Rules Database 235; a Redemption Catalog Database 240; a Member Transaction History Database 245; and Analytical Data Mart Database 250; and/or a Redemption Order Database 255.

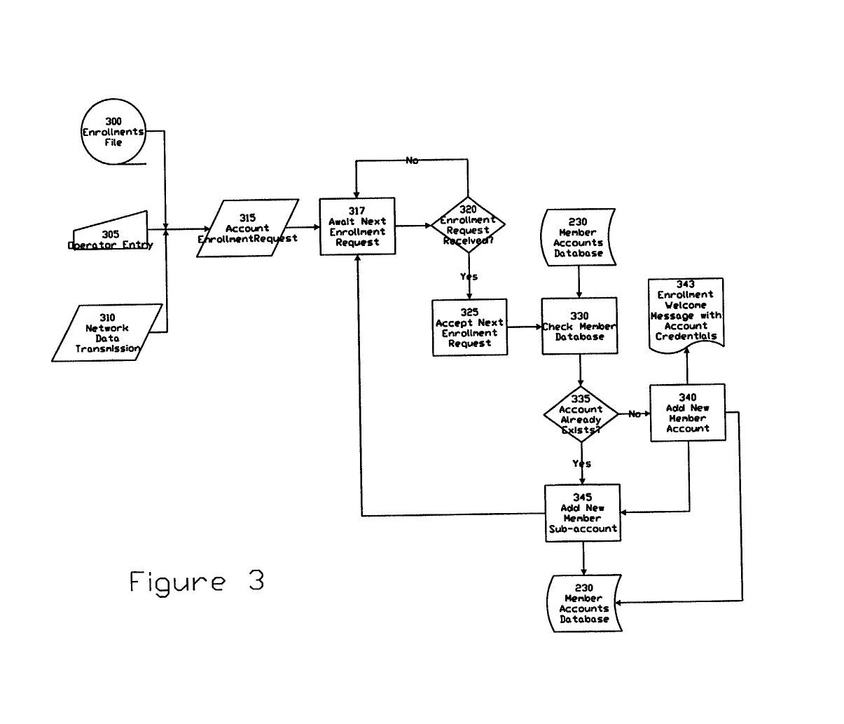

FIG. 3 depicts Member enrollment, a process that may, but need not, be executed on the Incentive Reward Processing Computer shown in FIG. 2, item 220. FIG. 3, step 317 awaits an Account Enrollment Request, 315, to establish a new Member account in the program. In the preferred embodiment an Account Enrollment Request, 315, may originate from any of several sources, such as an enrollments file, 300, a sequential file of enrollment requests delivered on any electronic medium, from operator entry 305, a direct operator entry through an interactive user interface, or from network data transmission 310, a data transmission delivered over a network such as the Internet or even an intranet.

In an alternative embodiment, an Account Enrollment Request, 315 could be obtained from other sources, such as a smart card reader or a text scanner, or any other type of data entry device. If the result of step 320 in FIG. 3 is negative, the process returns to step 317. Thus, in a continuous loop, steps 317 and 320 await an enrollment request.

If the result of FIG. 3, step 320 is positive, indicating that an enrollment request has been received, step 325 accepts the request. In FIG. 3, step 330 the Member Accounts Database 230 is queried to determine whether the Member has been enrolled previously in the program. If the Member is not found in the Member Accounts Database 230, the new Member is added to the Member Accounts Database, 230, in step 340. In step 340, an Enrollment Welcome Message 343 is also entered, including the Member's program credentials, in the form of a unique Member Username and a Password.

In the preferred embodiment of the disclosed invention, this message may be delivered to the newly enrolled Member in any form, including electronic mail, postal mail, or any other form of private, personal communication. The new Obligation, an element of the Account Enrollment Request, 315, is then added in step 345 to that Member account as a sub-account. If the Member is found by step 335 to exist in the Member Accounts Database, then the new Obligation is added to that existing Member account. Upon completion of the enrollment, the process resumes with step 317 to await the next Account Enrollment Request, 315.

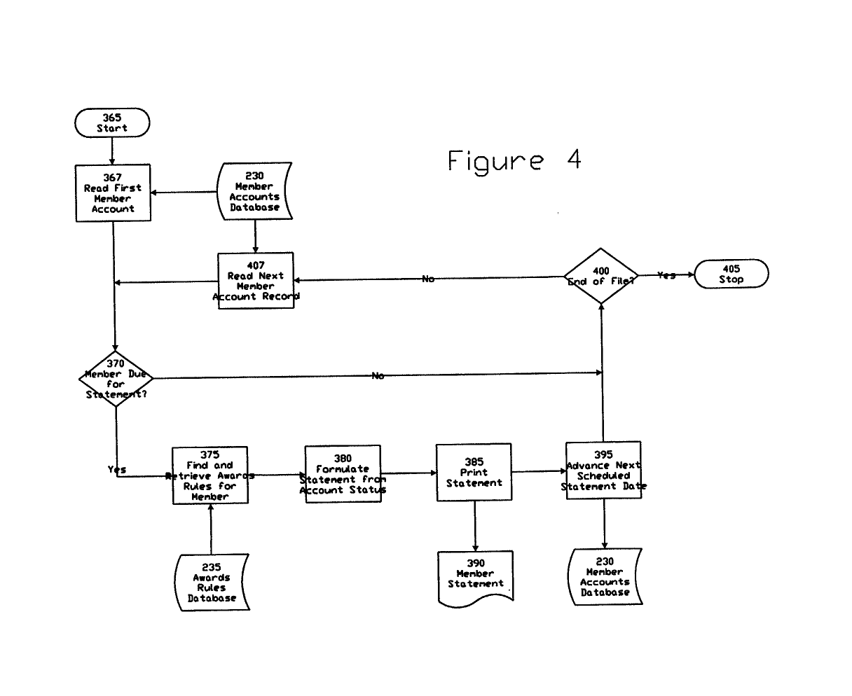

FIG. 4 depicts issuance of account statements, a process that may, but need not, execute on the Incentive Reward Processing Computer shown in FIG. 2, item 220. The process starts at step 365 when invoked by some external agent such as a system operator. In step 367, the first Member account in the Member Accounts Database 230 is read. The account is analyzed in step 370 to determine whether the Member is due to receive an account statement. If the result of step 370 is negative, the process proceeds to step 400 to determine whether it has stepped through all accounts whose Members may be due to receive statements. If the result of step 400 is negative, the process continues in step 407 by reading the next sequential Member account record. If the result of step 400 is positive, meaning that the final account has been processed, the process terminates at step 405.

If the result of FIG. 4, step 370 is positive the appropriate award rules are located and retrieved in step 375 from the Awards Rules Database 235. The data contained in the Member record are then combined with the appropriate awards rules to formulate a Member Account Statement, 380, which is then printed in step 385 to produce a document, 390, of the form depicted in generalized form in FIG. 35. In an alternative to the preferred embodiment, the contents of the statement may be forwarded to another device or to a third-party service bureau to be printed and delivered to the Member. After printing the statement, or causing scheduling an external system to print the statement, the Member Account is updated FIG. 4, step 395 to reflect the next scheduled statement date. The process repeats as necessary, as determined by checking for the end of the sequence of Member accounts in step 400.

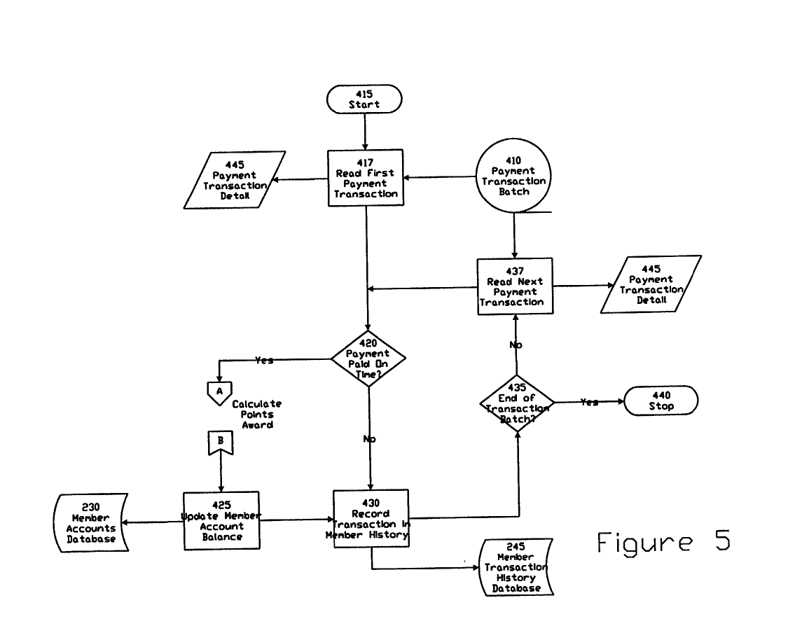

FIG. 5 depicts the processing of payment transactions to qualify them for Points awards and to calculate those awards, a process that may be executed on the Incentive Reward Processing Computer shown in FIG. 2, as item 220. The process starts at step 415 when invoked by some external agent such as a system operator. In step 417, the first payment transaction in a batch of transactions, 410, is read.

In an alternative embodiment of the present invention, payment transactions may be received by any of several means, such as interactive entry by an operator, a text scanner, a smart card reader, or transmission from another computer system over a network such as the Internet. The process in step 417 stores the Payment Transaction Detail, 445, in the system memory pending further processing. In FIG. 5, step 420, the process evaluates whether the payment paid on time, that is, on or before the scheduled due date. If the result of step 420 is negative, the process proceeds to step 430, where it records the transaction in the Member Transaction History Database 245.

If the result of step 420 is positive, the process proceeds to A and returns at B from a sub-process described below in which the actual Points award is calculated. After calculating the Points award, in step 425 the process updates the Member account in the Member Accounts Database 230, then proceeds to step 430 where it records the payment transaction in the Member Transaction History Database 245.

After completing FIG. 5, step 430, the Incentive Reward Processing Computer 220 determines whether it has reached the end of the current batch of payment transactions in step 435. If the result of step 435 is positive, the process terminates in step 440. If the result of step 435 is negative, the next transaction is read in step 437 and the process repeats, beginning with step 420 until the entire transaction batch 410 has been exhausted.

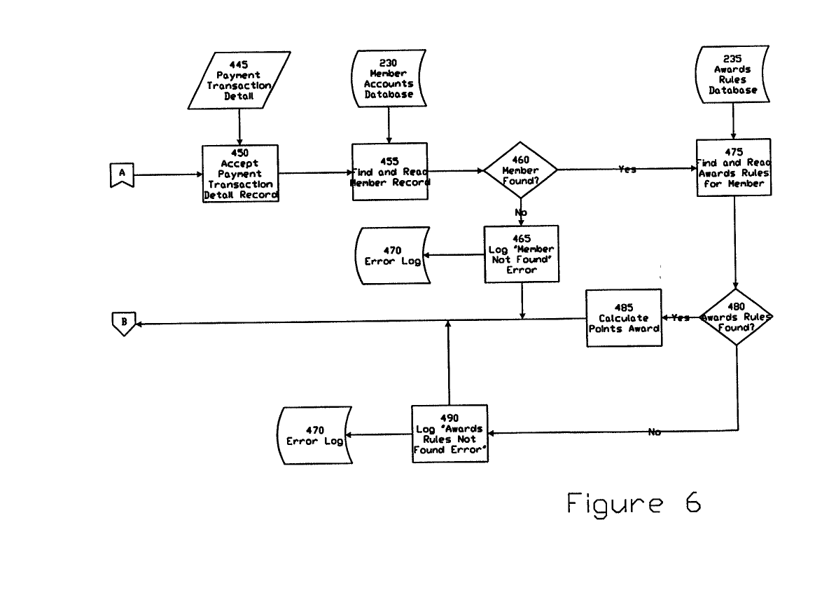

With reference to FIG. 6, after receiving a request from a process by entry point A, a Points award is calculated by reading the Payment Transaction Detail 445 in step 450. The process in step 455, searches the Member Accounts Database for the Member identified in the Payment Transaction Detail. If the result of step 460 is negative, the error is logged by step 465 in the Error Log Database 470. If the result of step 460 is positive, the process in step 475 retrieves the awards rules from the Awards Rules Database 235. In step 480 the process evaluates whether the appropriate awards rules were found. If the result of step 480 is negative, the process proceeds to step 490, which records the error in the Error Log Database 470. If the result of step 480 is positive, the award is calculated in step 485 based on the Payment Transaction Detail 445, the Member account, and the appropriate awards rules. The process then returns to the superior process from which it was invoked by means of reference B.

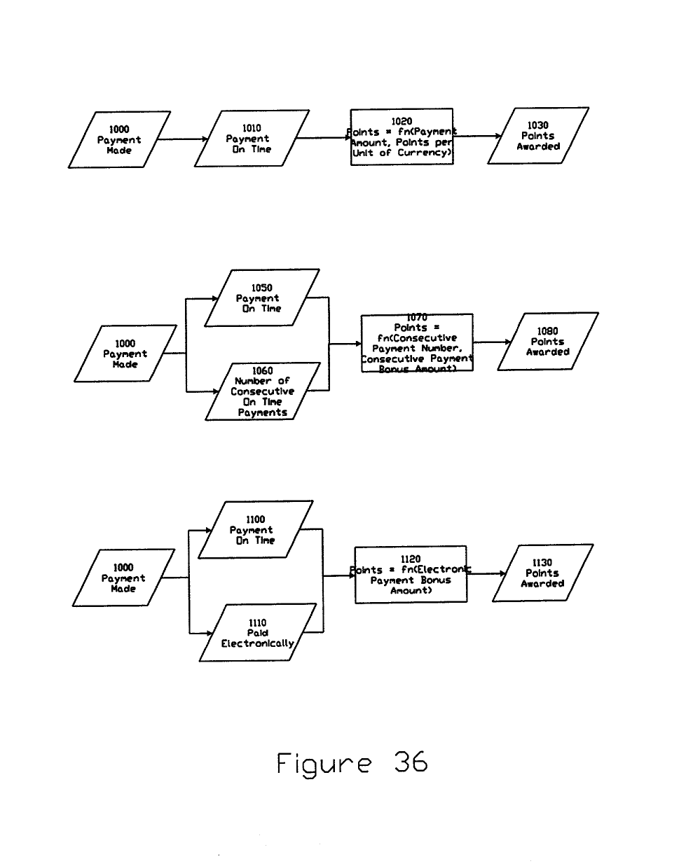

FIG. 36 depicts examples of three rules by which Points may be awarded in the program. In step 1020, a Points award is calculated by extracting the necessary details, 1010, from the Payment, 1000 and applying a mathematical function based on the total amount of the payment and the number of Points to be awarded per unit of currency paid. The specific constants required to evaluate this expression would be stored as elements of a Rule Record in the Awards Rules Database (FIG. 2, item 235).

FIG. 36, step 1070, a Points award is calculated by extracting the necessary details, 1050 and 1060, from the Payment, 1000 and applying a mathematical function based on the number of consecutive on-time payments received and the specified number of Points to be awarded for consecutive payment performance. The specific constants required to evaluate this expression would be stored as elements of a Rule Record in the Awards Rules Database (FIG. 2, item 235).

In FIG. 36, step 1120, a Points award is calculated by extracting the necessary details, 1100 and 1110, from the Payment, 1000 and applying a mathematical function based on the specified number of Points to be awarded for payments made electronically, such as by ACH or through an online bill payment system. The specific constants required to evaluate this expression would be stored as elements of a Rule Record in the Awards Rules Database (FIG. 2, item 235).

The results of all three Points Awards, as depicted by FIG. 36, steps 1030, 1080, and 1130, could be awarded individually or in any combination. Thus, a single payment could trigger and combine the results of an arbitrary number of Points awards, as determined by the rules stored in the Awards Rules Database (FIG. 2, item 235).

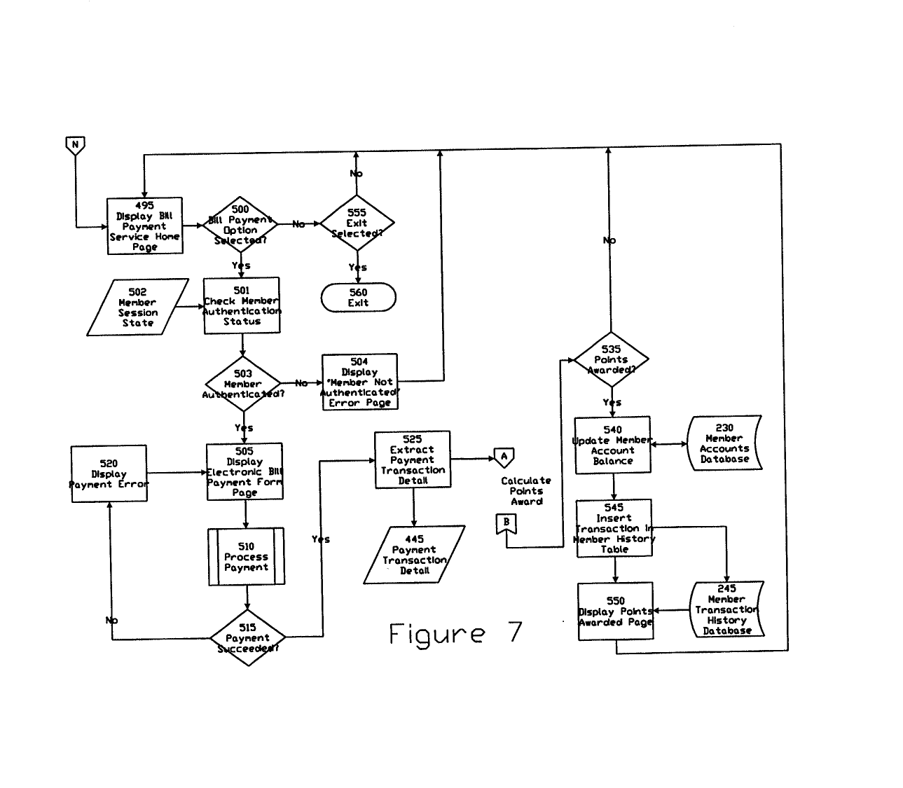

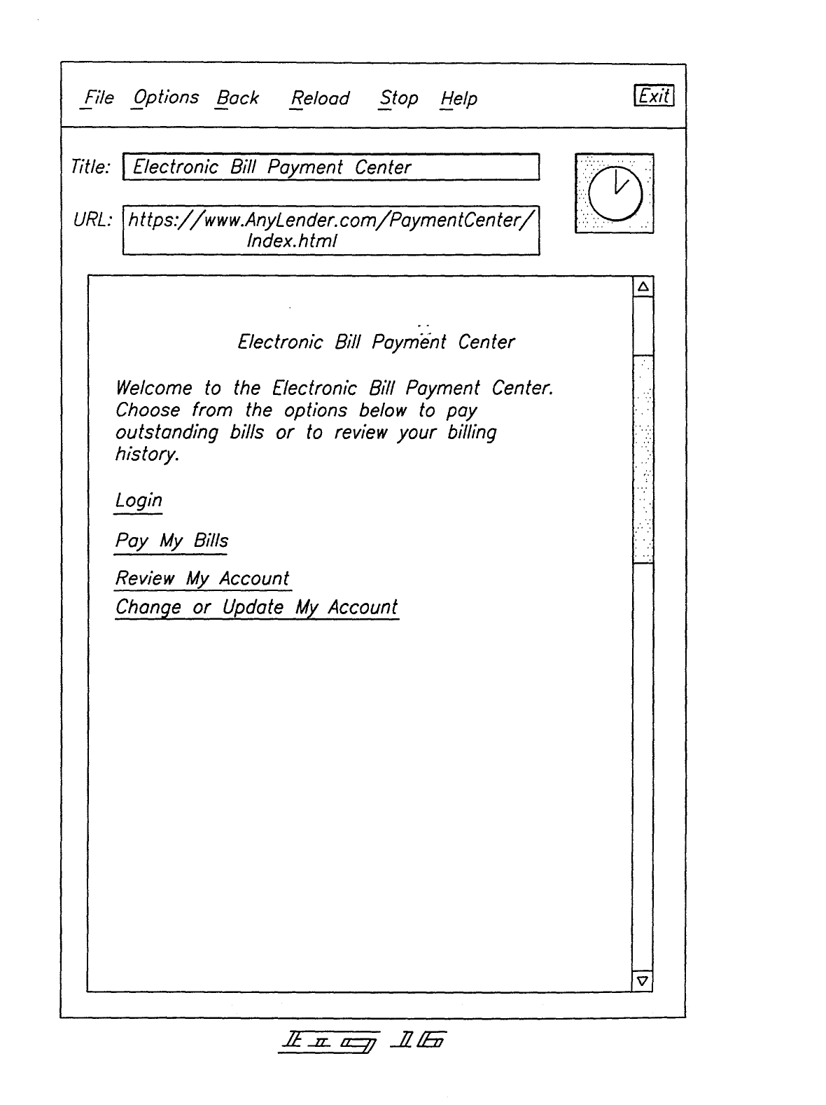

In FIG. 7, step 495 the Member Access Server Computer (FIG. 2, item 225) sends a bill payment service home page as shown in FIG. 16, in the form of a hypertext document, to the Member Personal Computer (FIG. 2, item 215). In an alternative embodiment of the present invention, a user interface similar to that depicted in FIG. 16 and delivered to the Member Personal Computer 215 could take the from of an application program that runs directly on the Member Personal Computer instead of a hypertext document presented by a Web browser or other hypertext display application. A person skilled in the art will understand that the specific technology employed to present the options and input fields on this and all subsequent user interface elements presented as components of the disclosed invention may change in accordance with advances in networked communications systems.

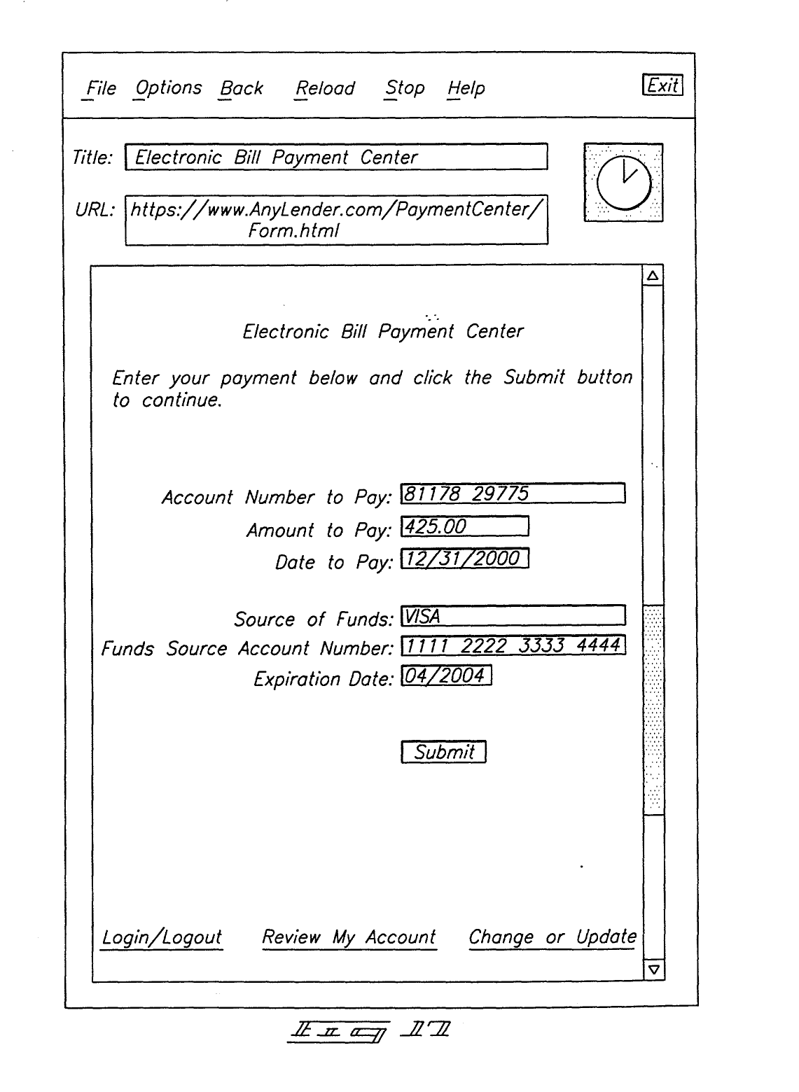

At FIG. 7, step 500 the Member, connecting to the Member Access Server Computer (FIG. 2, item 225) from N, may select the Bill Payment option. If this option is selected, the Member Access Server Computer (FIG. 2, item 225) checks the Member's authentication status at step 501 by reading the Member Session State 502. In step 503, the process evaluates whether the Member is authenticated. If the result of step 503 is negative, the process sends the Member an error page (step 504) before returning them to the Bill Payment Service Home Page displayed by step 495. If the result of step 503 is positive, the Member Access Server Computer (FIG. 2, item 225) in step 505 sends the Electronic Bill Payment Form depicted in FIG. 17, in the form of a hypertext document or a programmed application interface, to the Member Personal Computer (FIG. 2, item 215).

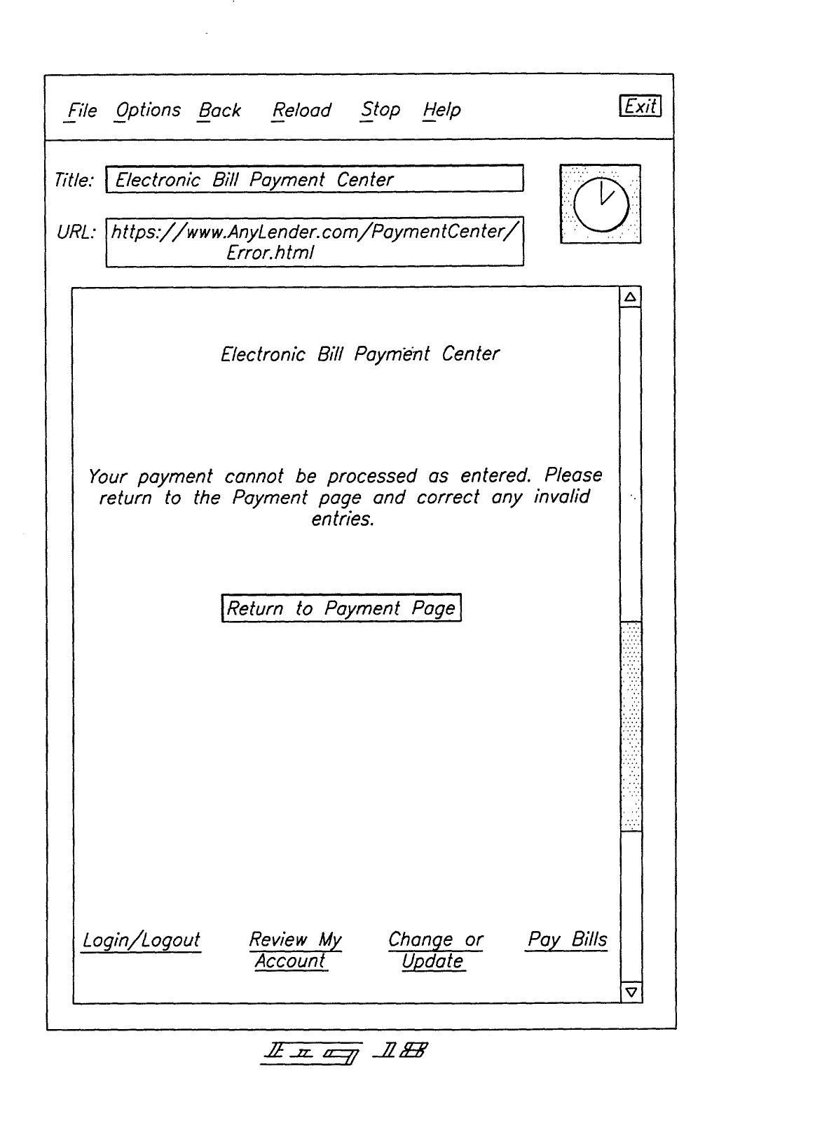

In FIG. 7, step 510, the Installment Payment Processing Computer (FIG. 2, item 205) processes the payment submitted in 505, updating the Member's Obligation account within the Creditor's accounts receivable system, an external process whose details are not germane to the present invention and is not detailed here. A person skilled in the art will understand that various systems of varying complexity are used by Creditors to process accounts receivables. Step 515 evaluates whether the processing performed in step 505 is successful. If the result of step 515 is negative, the Member Access Server Computer (FIG. 2, item 225) sends an error notification page, as depicted in FIG. 18, in the form of a hypertext document or as a programmed application interface, to the Member Personal Computer (FIG. 2, item 215). If the result of step 515 is positive, the Payment Transaction Detail, 445, is extracted from the payment in step 525. The process calls and returns from the process depicted in FIG. 6, by way of connection points A and B respectively, the sub-process described above with reference to FIG. 6, in which an award of Points is calculated.

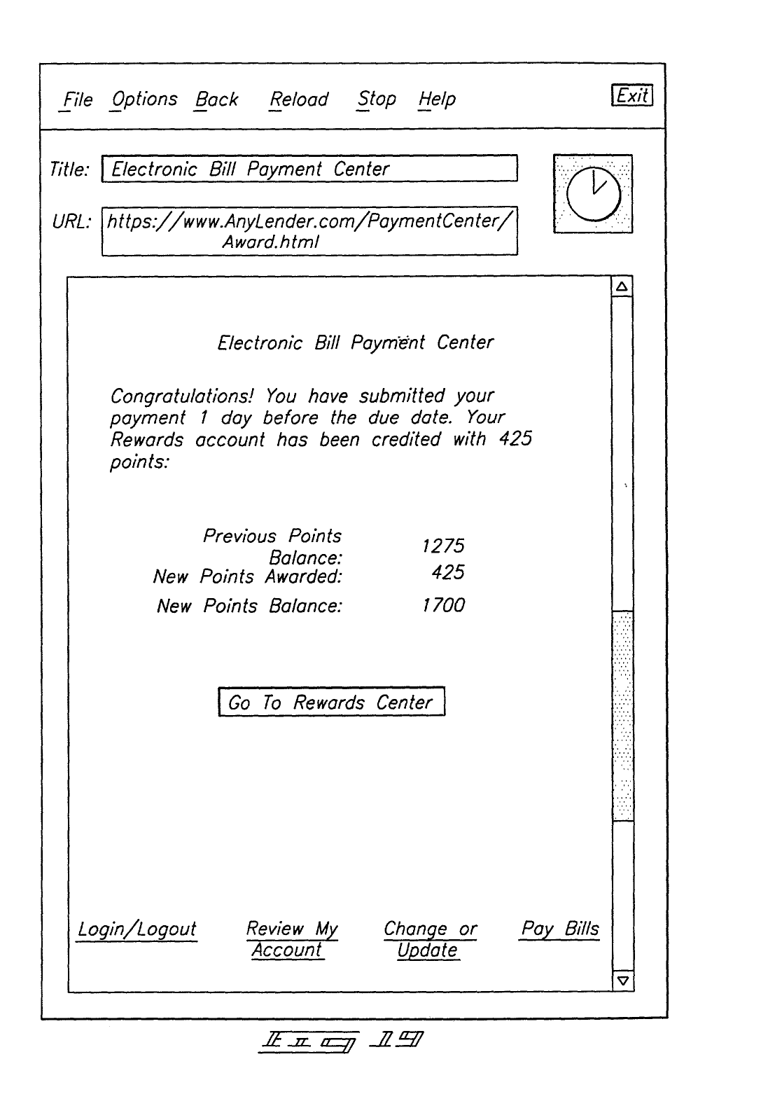

After calculating the Points award, the process continues at FIG. 7, step 535 where it evaluates whether the calculation of the Points award succeeded. If the result of step 535 is negative, the process returns to step 495. If the result of step 535 is positive, the Member Accounts Database, 230, is updated at step 540. Next, in step 545 the Points award transaction is recorded in the Member Transaction History Database, 245. Finally, the Member Access Server Computer (FIG. 2, item 225) sends a page, as depicted in FIG. 19, in the form of a hypertext document or a programmed application interface, to the Member Personal Computer (FIG. 2, item 215), indicating that the payment was processed successfully and reporting the number of Points awarded, if any. After viewing this page, the Member returns to the Bill Payment Service Home Page (FIG. 16) displayed by step 495.

If the Member selects the Exit option from the Bill Payment Service Home Page (FIG. 16) , as determined in FIG. 7, step 555, then the dialog between the Member Personal Computer (FIG. 2, item 215) and the Member Access Server Computer (FIG. 2, item 225) terminates and exits at step 560.

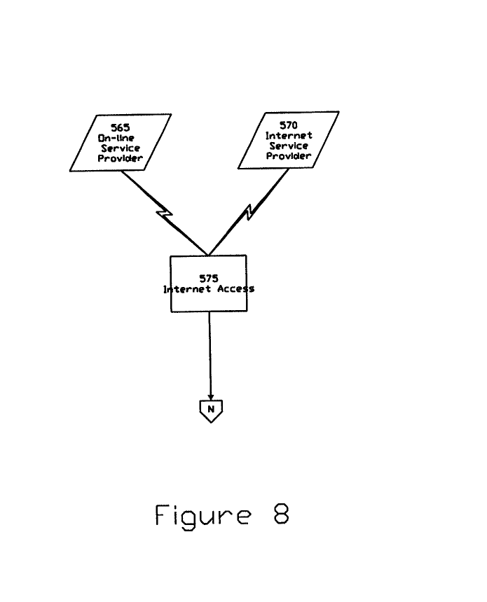

With reference to FIG. 8, a Member using a Member Personal Computer (FIG. 2, item 215) obtains access to the Member Access Server Computer (FIG. 2, item 225) by means of a data communications network, such as the Internet. The Member Personal Computer connects to the communications network, 575, either through an On-line Service Creditor, 565, or through an Internet Service Creditor, 570. Once connected to the network, Members communicate with processes executing on the Member Access Service Computer, represented by N in FIG. 8. In the preferred embodiment of the present invention, the Member Personal Computer may take the form of any of several devices, such as, but not limited to stationary personal computers, handheld computers, data-enabled wireless telephones, and networked personal digital assistants. Furthermore, communication may occur over any combination of all available networks, including but not limited to physical analog telephone lines, digital telephone lines, and wireless data transmissions.

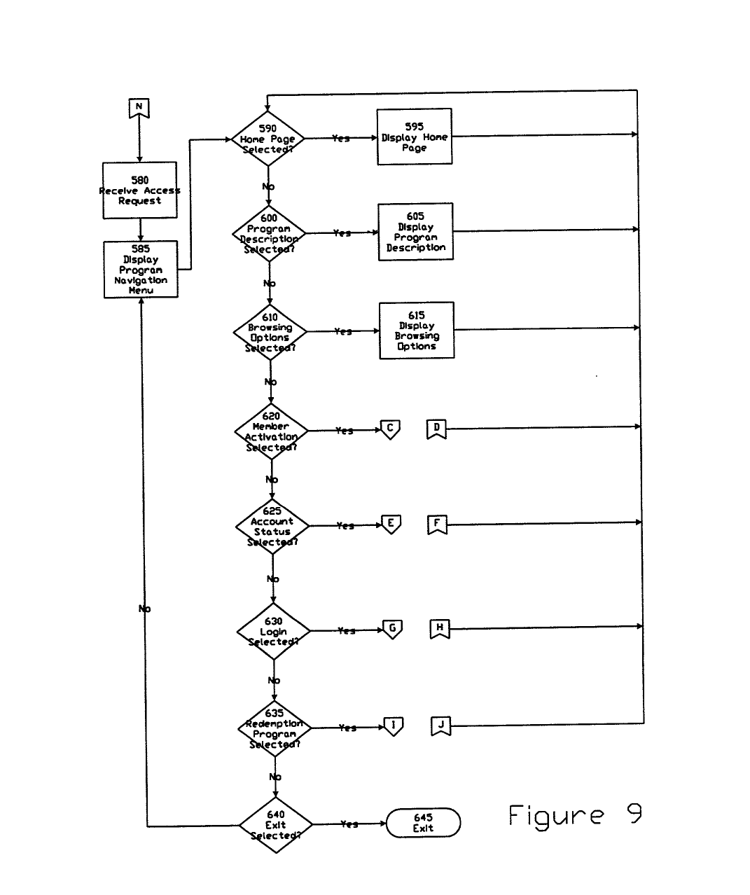

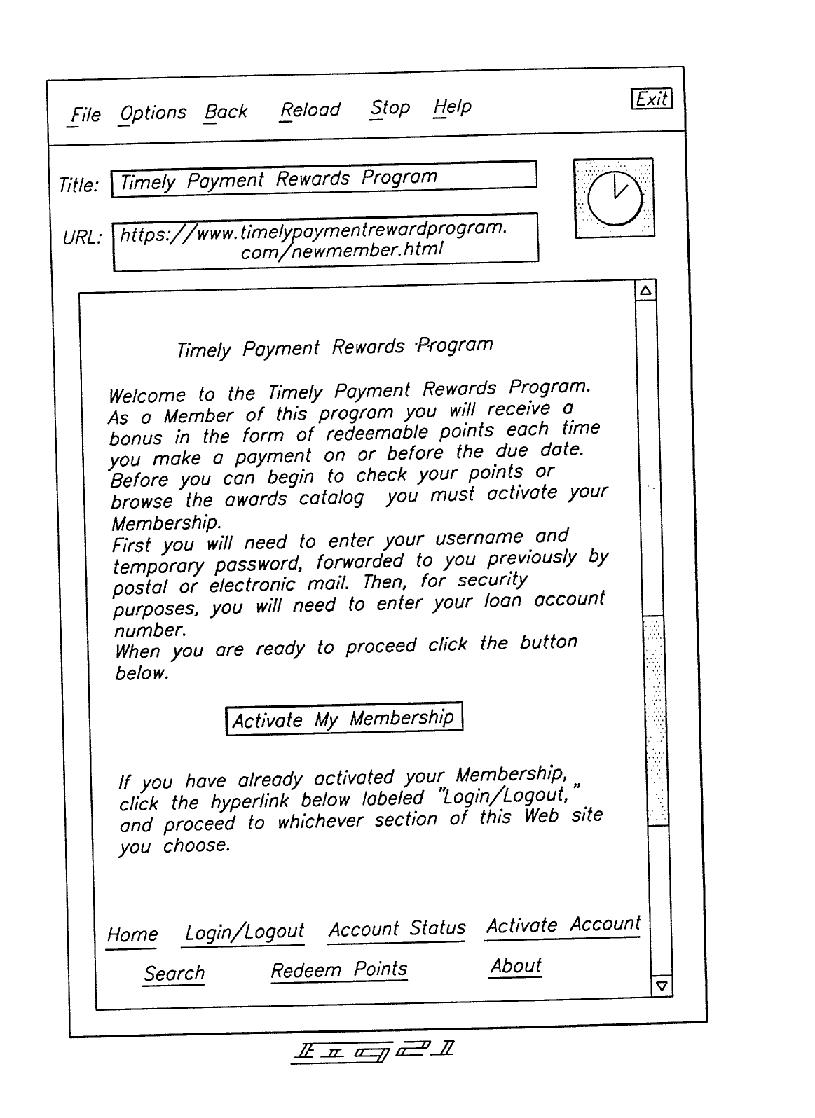

FIG. 9, depicts primarily the choices presented to the Member when they arrive at the online customer service system home page. In step 580, the Member Access Server Computer (FIG. 2, item 225) receives a request from the Member Personal Computer (FIG. 2, item 215). The Member Access Server Computer responds in step 585 by sending to the Member Personal Computer, in the form of a hypertext document or as a programmed application interface, the Program Navigation Menu, as illustrated by the seven hyperlinks shown in FIG. 21: Home, Login/Logout, Account Status, Activate Account, Search, Redeem Points, and About. From this menu, the Member may select any of the seven options as required or exit from the application.

In an alternative embodiment of the disclosed invention, this Program Navigation Menu may comprise a fewer or greater number of options as required by the particular program. For example, the electronic bill payment option described above and depicted primarily in FIG. 7 may be offered directly through the timely payment rewards program instead of, or in addition to other online services offered by the Creditor, and therefore become listed as an option on the Program Navigation Menu.

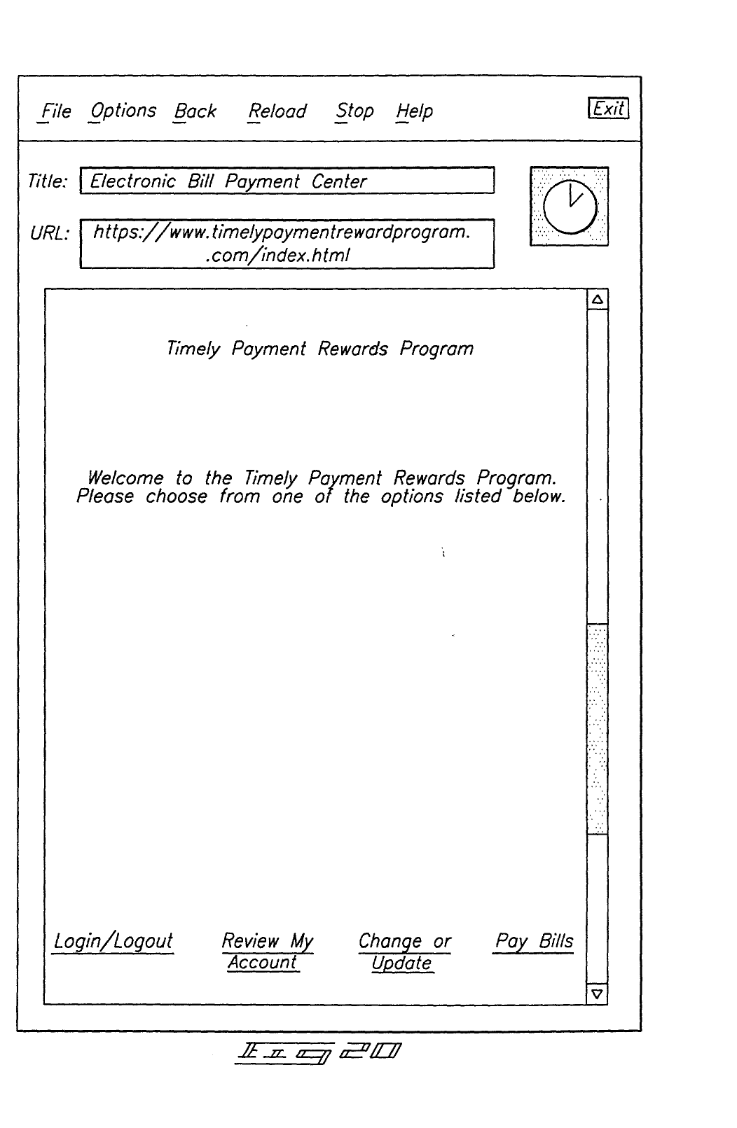

It should be noted that in the preferred embodiment of the disclosed invention, the user might backtrack from any particular point in the program. Notably the user is able to return to the selection menu depicted in FIG. 20 from any part of the program. Furthermore, the Program Navigation Menu may appear on any or all pages or program interface screens in the application, creating a multiplicity of navigational paths through the application. Thus, a Member could arrive at any of the screens described herein from a selection made on any other screen. This being stated generally, a person skilled in the art will appreciate that these features are applicable to the further program steps of the preferred embodiment described below, and therefore it will not be repeated in the following description.

In FIG. 9, step 590, the Member Access Server Computer checks whether the Member has selected the option to view the Program Home Page. If the result of step 590 is positive, the Home Page is sent in step 595 to the Member Personal Computer (FIG. 2, item 215) in a form similar to that depicted in FIG. 20. If the result of FIG. 9, step 590 is negative, the process proceeds to step 600, which determines whether the Program Description option has been selected.

If the result of FIG. 9, step 600 is positive, a description of the timely payment rewards program is sent in step 605 to the Member Personal Computer (FIG. 2, item 215). If the result of step 600 is negative, the process proceeds to step 610, which determines whether the Browsing Options option has been selected.

If the result of FIG. 9, step 610 is positive, a page displaying the browsing options is sent in step 615 to the Member Personal Computer (FIG. 2, item 215). In the preferred embodiment, the capability to locate specific items of interest within the program is enhanced by providing the user with various browsing options, generally presented to the user in the form of hyperlinks, form fields, or icons, or a combination of such presentation elements. For example, the user may choose to search the entire application to locate pages that contain particular keywords. Any conventional search engine may be used for this purpose. Such a search engine can be implemented to accept a Boolean string, or by collecting the user's response to an inquiry set. The fields for the search engine may include, for example, key words, brands, price ranges, product categories, etc. If the result of FIG. 9, if step 610 is negative, the process proceeds to step 620, which determines whether the Member Activation option has been selected.

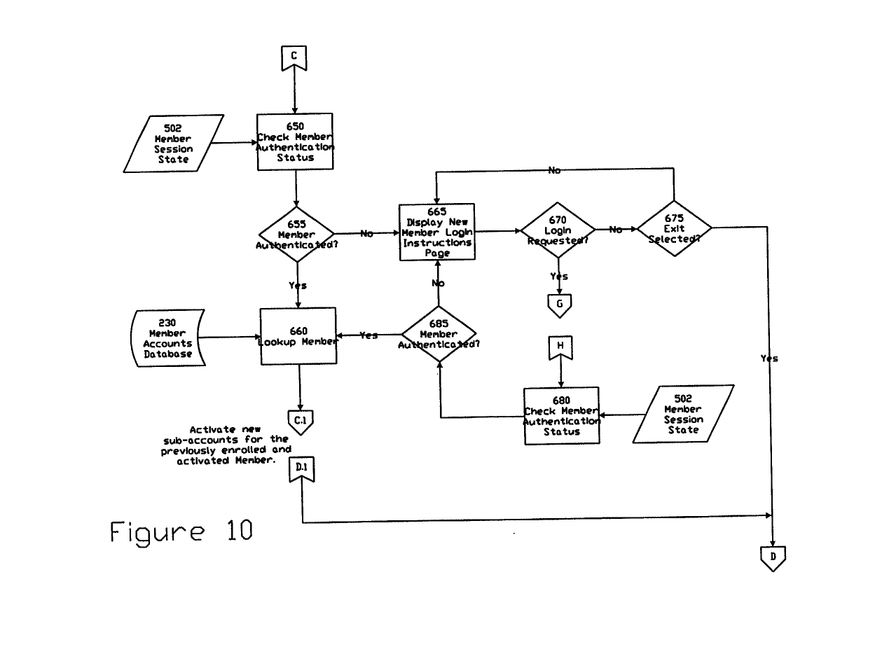

If the result of FIG. 9, step 620 is positive, the process proceeds to C, a reference to the process depicted in FIG. 10. Upon completion of that sub-process, it returns at D and returns to the Home Page (step 590). If the result of step 620 is negative, the process proceeds to step 625, which determines whether the Account Status option has been selected.

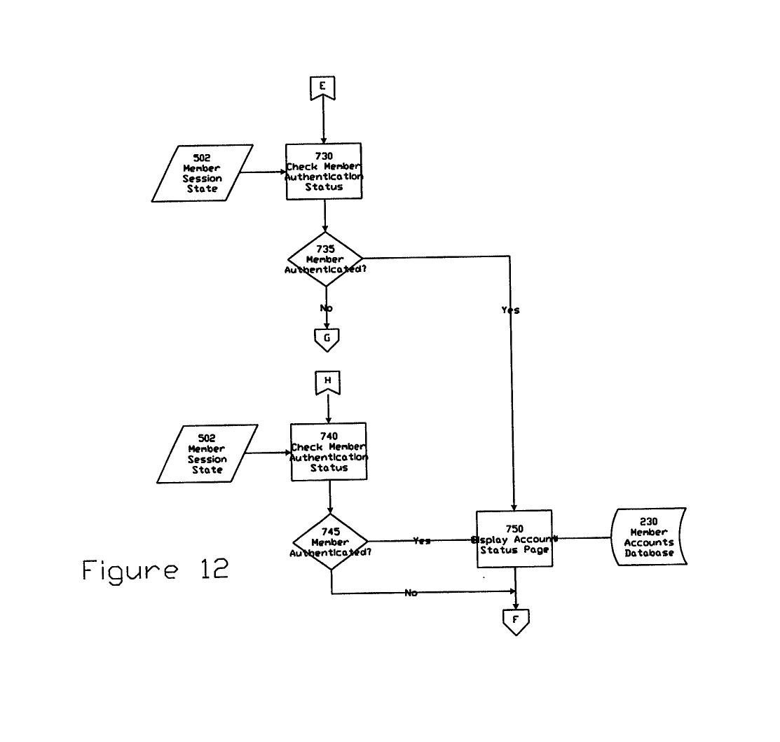

If the result of FIG. 9, step 625 is positive, the process proceeds to E, a reference to the process depicted in FIG. 12. Upon completion of that sub-process, it returns at F and returns to the Home Page (step 590). If the result of step 625 is negative, the process proceeds to step 630, which determines whether the Login option has been selected.

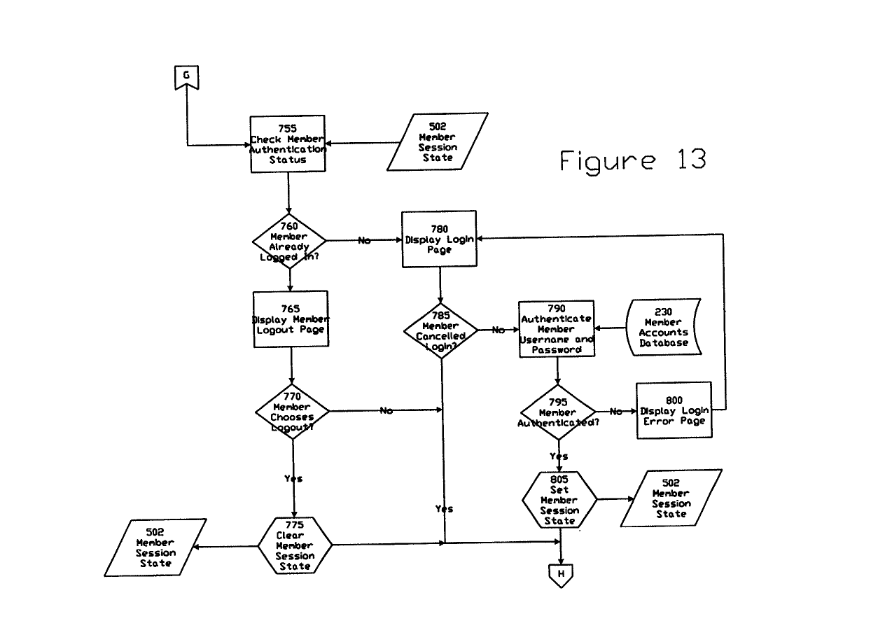

If the result of FIG. 9, step 630 is positive, the process proceeds to G, a reference to the process depicted in FIG. 13. Upon completion of that sub-process, it returns at H and returns to the Home Page (step 590). If the result of step 630 is negative, the process proceeds to step 635, which determines whether the Redemption Program option has been selected.

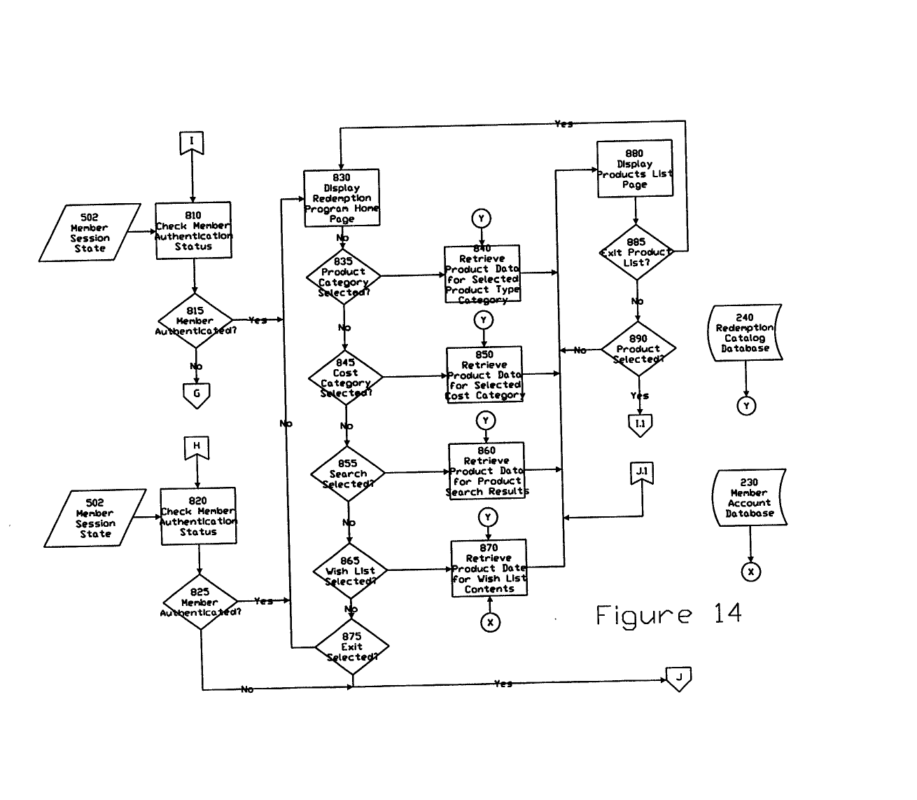

If the result of FIG. 9, step 635 is positive, the process proceeds to I, a reference to the process depicted in FIG. 14. Upon completion of that sub-process, it returns at J and returns to the Home Page (step 590). If the result of step 635 is negative, the process proceeds to step 640, which determines whether the Exit option has been selected.

If the result of FIG. 9, step 640 is positive, the process terminates at step 645. If the result of step 640 is negative, the process repeats by returning to step 585, which displays the Program Navigation Menu.

With reference to FIG. 10, a user who wishes to activate his or her enrollment in the timely payment rewards program will enter the depicted account activation process at C, a reference to the superior process depicted in FIG. 9. Please note that each Member may participate in the program by making payments to one or more enrolled Obligations, as established by the Creditor. In the Account Activation process, Members identify themselves to the program after having been pre-enrolled by the Creditor. They also must activate each individual Obligation by entering key piece of identifying information as described below.

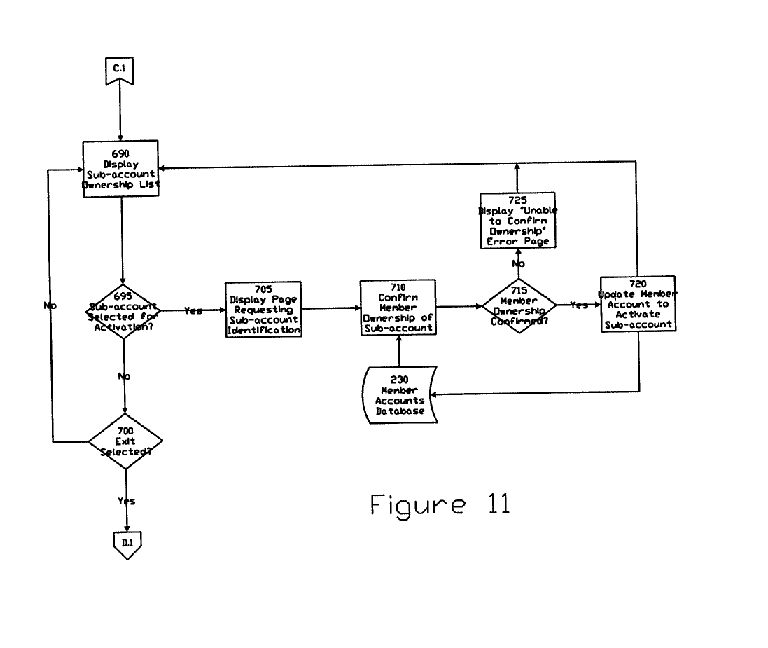

In FIG. 10, step 650, the Member Access Server Computer (FIG. 2, item 225) will check the authentication status of the user by reading the Member Session State, 502. If, according to step 655, the Member is authenticated, the Member account record is retrieved in step 660 from the Member Accounts Database, 230. The process then continues at C.1, a reference to the sub-process depicted in FIG. 11, returning at point D.1. After completion of the account activation process, the Member Access Server Computer (FIG. 2, item 225) returns to the process depicted in FIG. 9 at D. If the result of FIG. 10, step 655 is negative, meaning that the Member was not authenticated, then the New Member Login Instructions Page is sent to the Member Persona computer (FIG. 2, item 215) in a form similar to that depicted in FIG. 21. If the Member chooses to login to the program using his or her assigned Member Identification Name and Member Password, as determined in FIG. 10, step 670, then the process continues at G, a reference to the sub-process depicted in FIG. 13. After completing the login sub-process depicted in FIG. 13, Member Access Server Computer again analyzes the Member Authentication Status (FIG. 10, step 680). In step 685, the process evaluates whether the Member is now authenticated. If the result of step 685 is negative, the process returns to step 665.

If the result of FIG. 10, step 670 is negative, meaning that the user has not chosen to login, then step 675 evaluates whether the user has selected the option to exit from the account activation process. If the result of step 675 is negative, the process resumes at step 665. If the result of step 675 is positive, the process exits at reference point D to the superior process, depicted in FIG. 9.

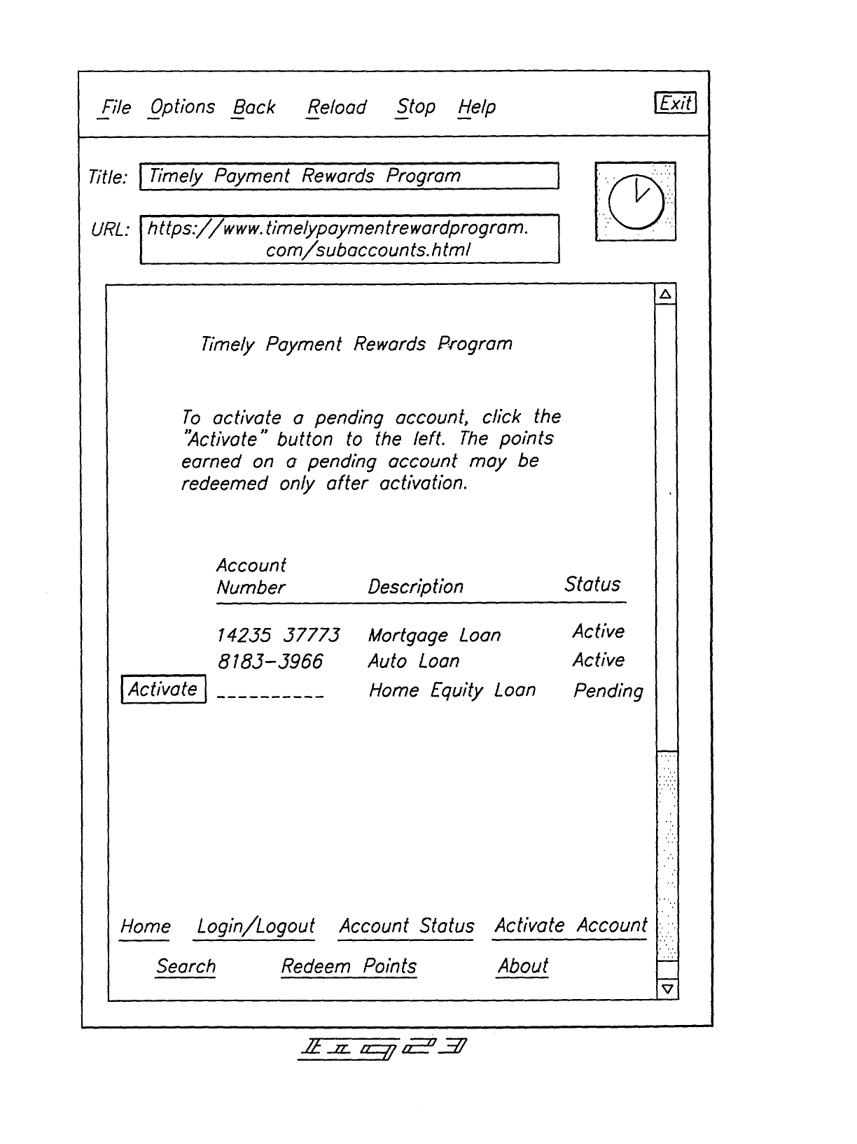

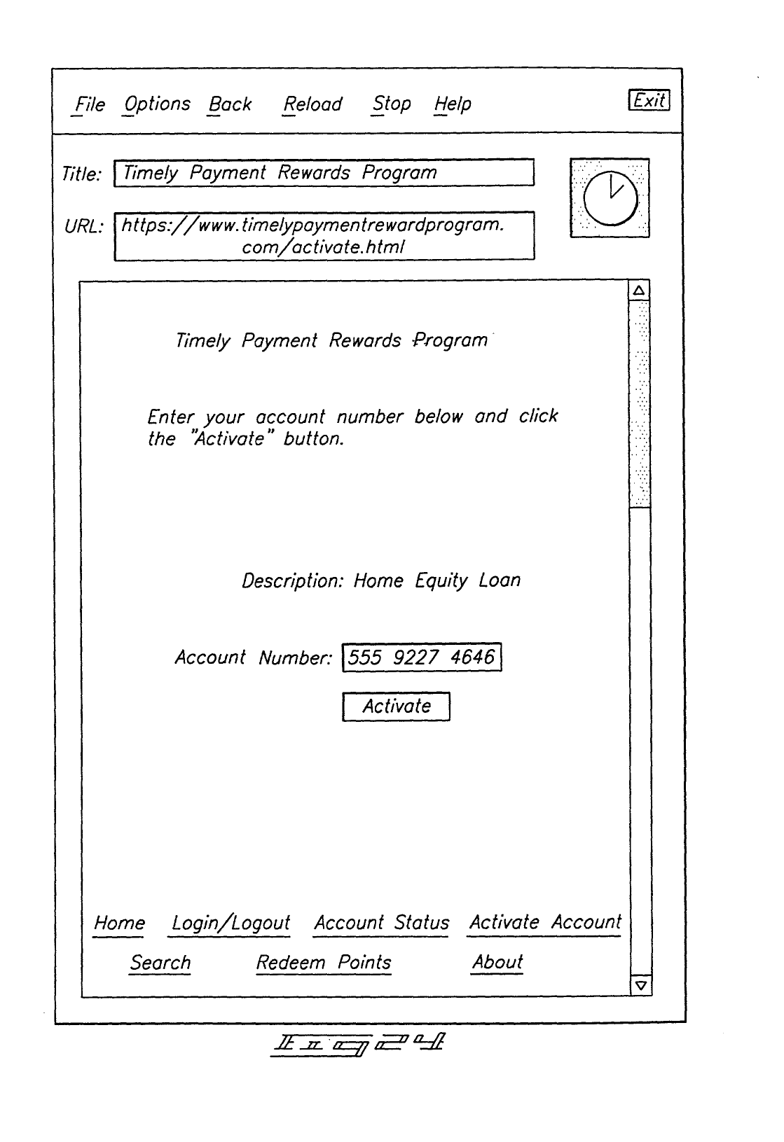

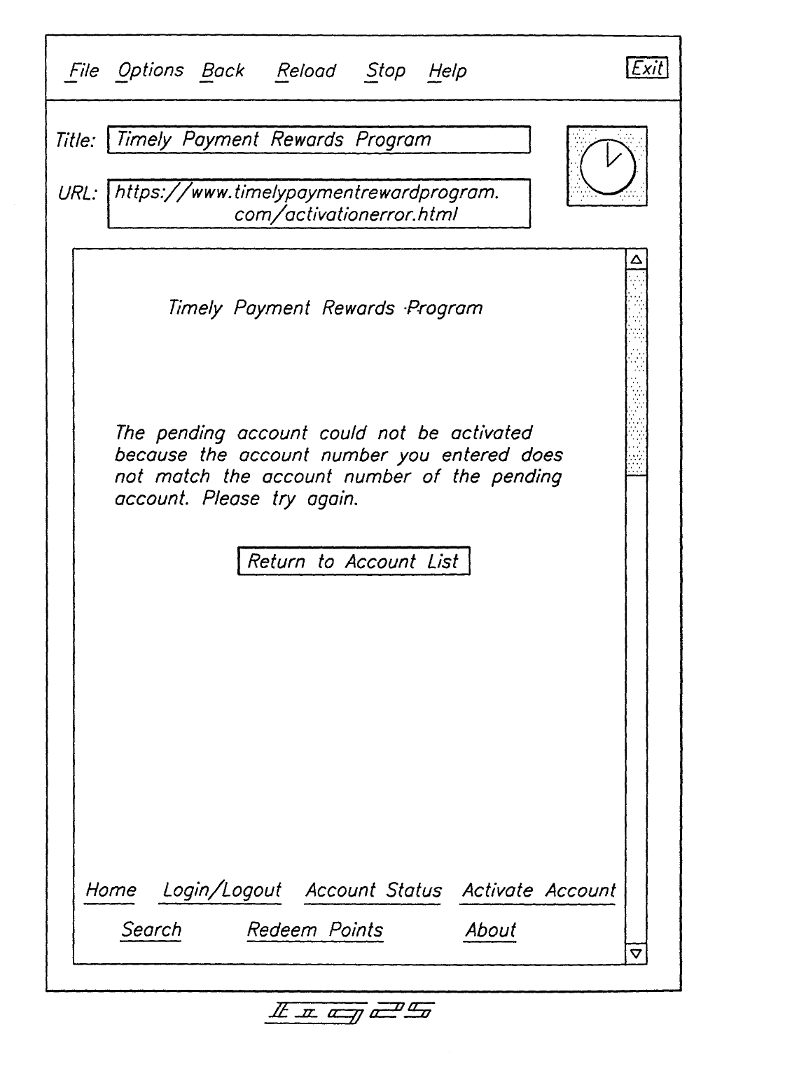

The process depicted in FIG. 11 describes the method by which a Member activates an Obligation, as enrolled by the Creditor. This sub-process is entered at C.1, a reference to the superior process depicted in FIG. 9, the Program Navigation Menu. In FIG. 11, step 690, the Member Access Server Computer (FIG. 2, item 225) sends a screen to the Member Personal Computer (FIG. 2, item 215) displaying the Sub-account Ownership List, in a form similar to that depicted in FIG. 23. FIG. 11, step 695 evaluates whether the user has selected a sub-account for Activation. If the result of step 695 is negative, then the process proceeds to step 700. If the result of step 695 is positive, then in FIG. 11, step 705, the Member Access Server Computer sends to the Member Personal Computer the Sub-account Identification form page, similar to that depicted in FIG. 24. Upon receiving the identifier submitted by the user in FIG. 11, step 705, the process attempts to confirm ownership of the Sub-account by the currently authenticated Member (step 710) as recorded in the Member Accounts Database, 230. Confirmation of Sub-account ownership is evaluated in step 715. If the result of step 715 is negative, an error page is displayed, similar to that depicted in FIG. 25. If the result of step FIG. 11, step 715 is positive, the Member Account is updated (step 720) in the Member Accounts Database, 230, and the process returns to step 690, in which the list of Sub-accounts is re-displayed, reflecting the change is status of the newly activated Sub-account.

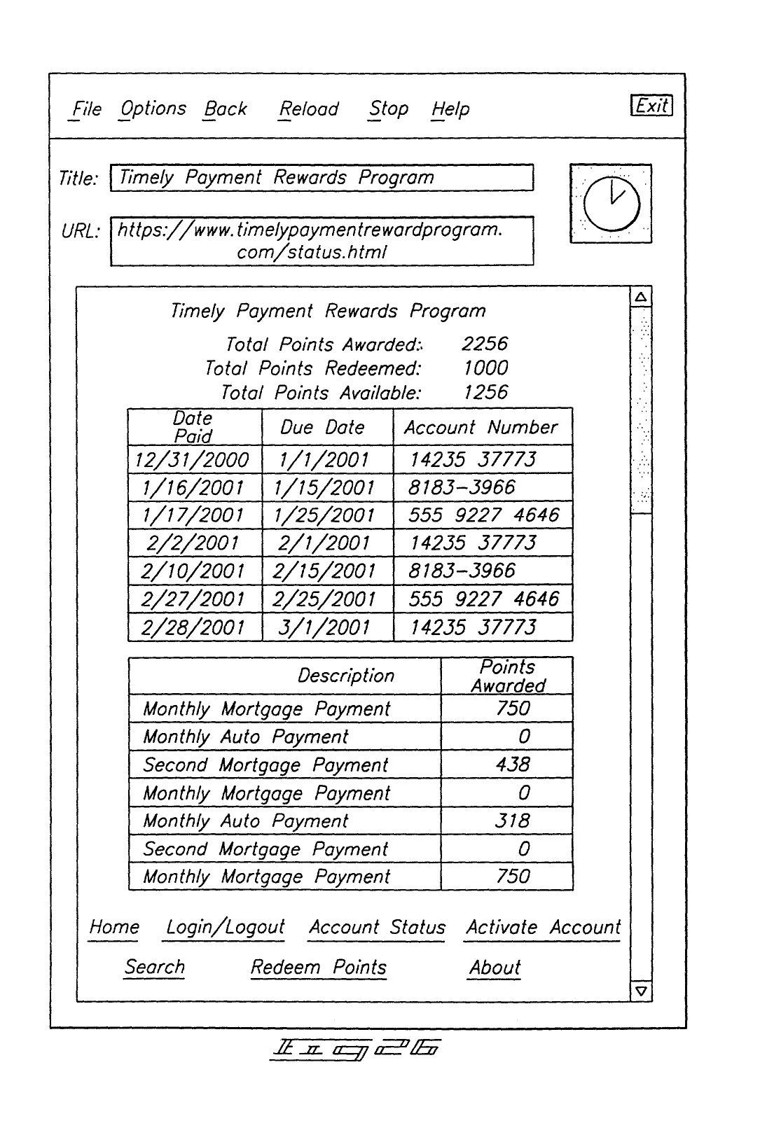

The process depicted in FIG. 12 describes the process by which a Member inquires as to the status of his or her program account, including such details as the current Points balance and the transactional history of payments and consequential Points awarded. This sub-process is entered at E, a reference to the superior process depicted in FIG. 9, the Program Navigation Menu. In FIG. 12, step 730, the Member Access Server Computer (FIG. 2, item 225) checks State, 502. Step 735 evaluates the results of step 730. If the result of step 735 is positive, indicating that the Member is authenticated, then in FIG. 12, step 750, the Account Status page or pages are assembled from the data in the Member Accounts Database, 230, and sent to the Member Personal Computer (FIG. 2, item 215) in a form similar to that depicted in FIG. 26. If the result of FIG. 12, step 735 is negative, indicating that the Member is not authenticated, then the process proceeds at G to the sub-process depicted in FIG. 13. After returning from that sub-process at H, the Member's authentication status is evaluated once again in FIG. 12, step 740. If, according to step 745, the Member has been successfully authenticated, the process resumes at step 750. If either authentication has failed according to FIG. 12, step 745, or the Account Status has been successfully displayed in step 750, the process returns at F to the superior process depicted in FIG. 9, the Program Navigation Menu.

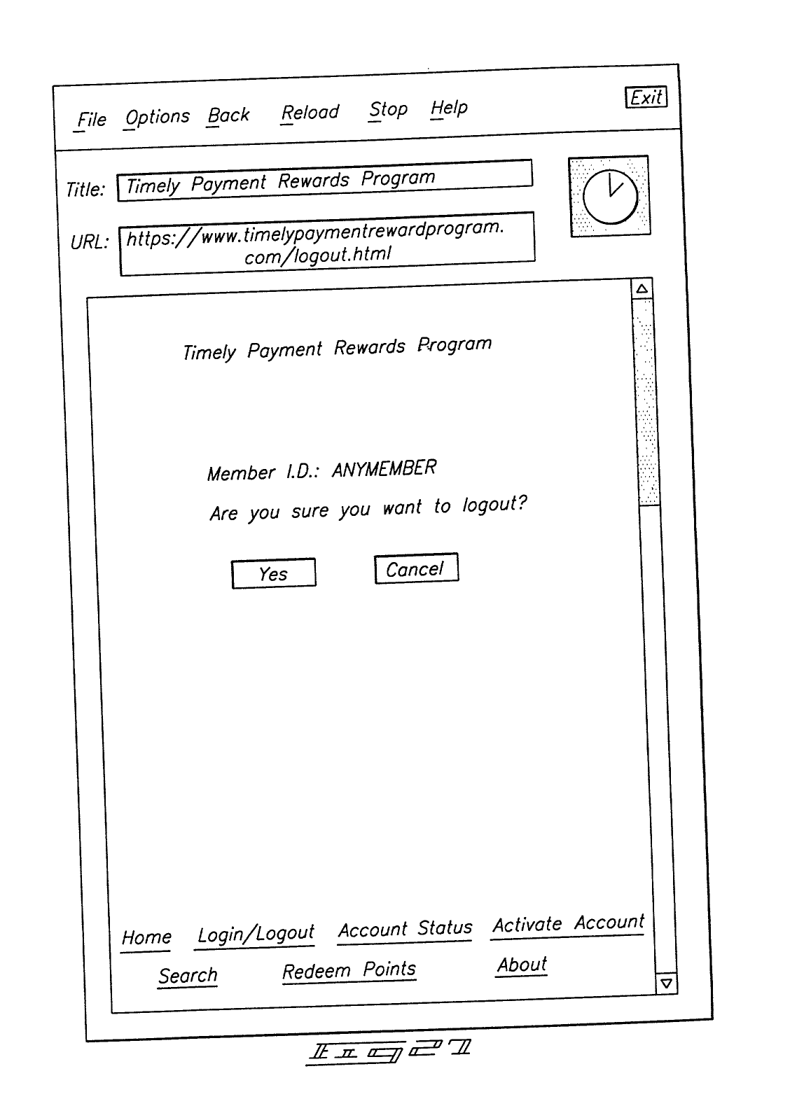

The process depicted in FIG. 13 describes the process by which a Member is authenticated by the program. After receiving a request to perform authentication from any other process in the program, as indicated by reference G, the Member Access Server Computer (FIG. 2, item 225) first checks in the current Authentication Status of the member in FIG. 13, step 755, by reading the Member Session State, 502. Step 760 analyzes the outcome of step 755. If the result of step 760 is positive, meaning that the Member is already authenticated, the Member Access Server Computer (FIG. 2, item 225) sends to the Member Personal Computer (FIG. 2, item 215) the Member Logout form, similar to the screen depicted in FIG. 27. If, according to FIG. 13, step 770, the Member chooses to logout, then the Member Session State 502 is cleared in step 775. If either step 775 is completed or the result of step 770 is negative, then the process returns at H to whichever superior process initiated the authentication request.

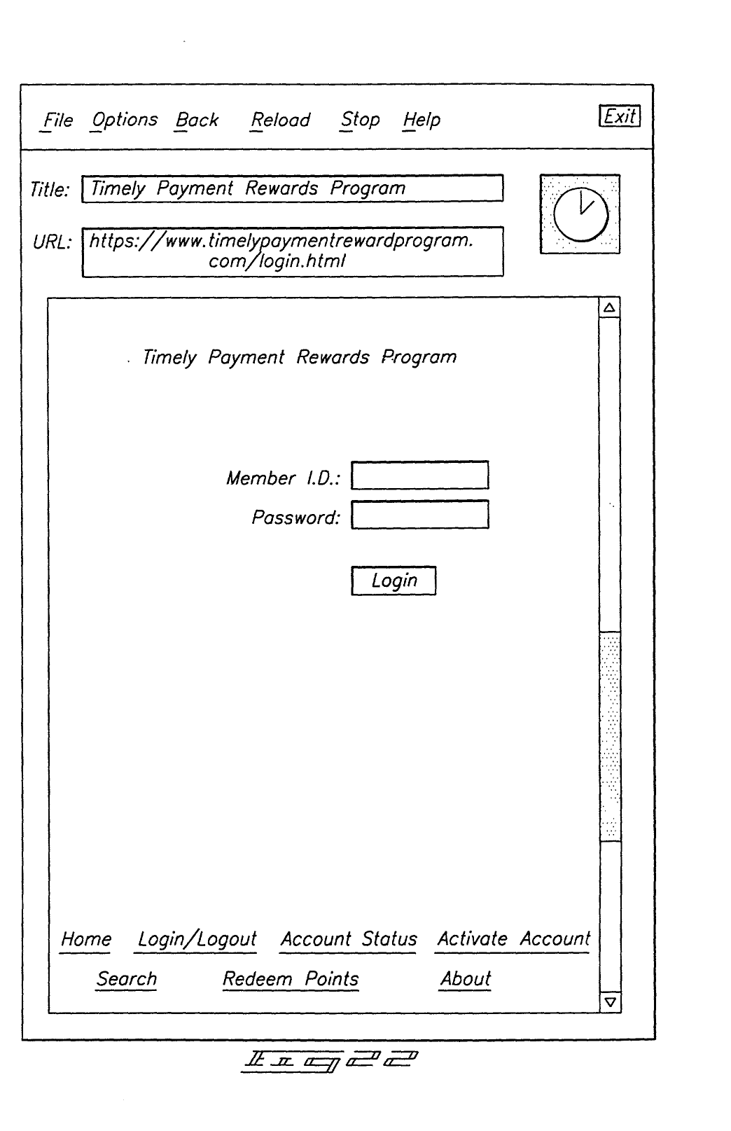

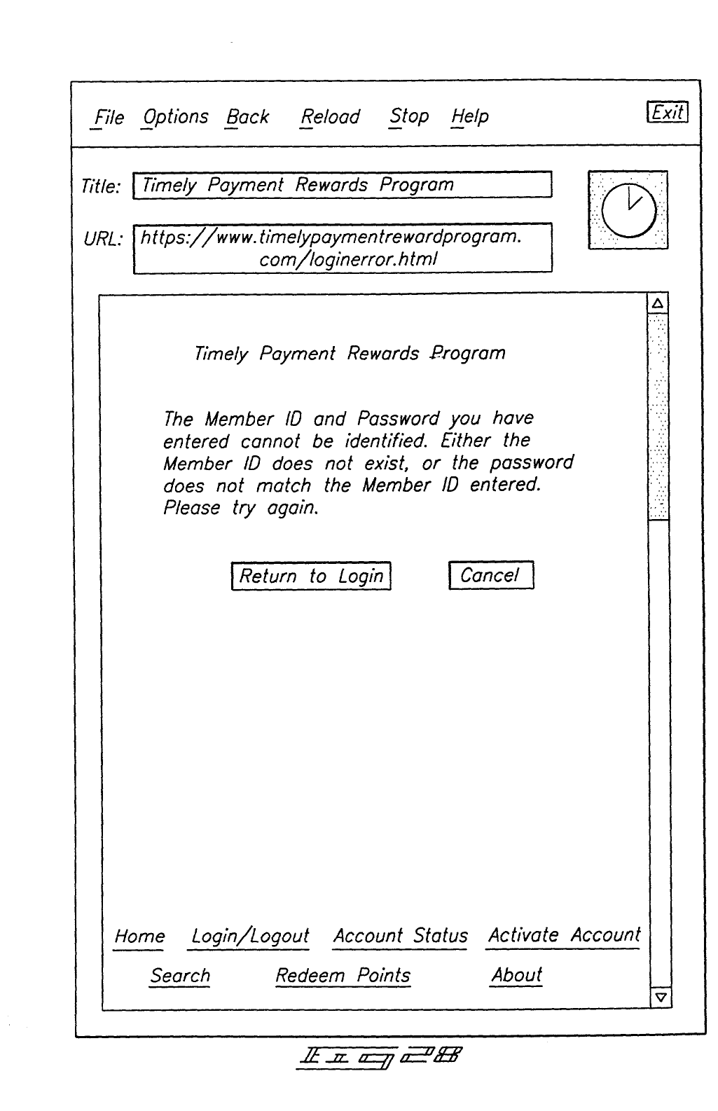

If the result of FIG. 13, step 760 is negative, meaning that the member has not been authenticated, the Member Access Server Computer (FIG. 2, item 225) causes the Member Personal Computer (FIG. 2, item 215) to display the Login page, similar to that depicted in FIG. 22. At FIG. 13, step 785, if the Member cancels his or her request to Login to the program, the process returns at H to whichever superior process initiated the request for authentication. If the result of step 785 is negative, meaning that the Member has submitted unique Member identification in the form of a username/membername and password, then at step 790 the process queries the Member Accounts Database 230 to locate a matching Member account. Step 795 evaluates the result of step 790 to determine whether authentication was successful, meaning that the Member Accounts Database does contain a Member account identified by the credentials submitted by the member. If the result of step 795 is negative, then in step 800 the Member Access Server Computer (FIG. 2, item 225) causes the Member Personal Computer (FIG. 2, item 215) to display an error page, similar to that depicted in FIG. 28, after which the process returns to step 780. If the result of step 795 is positive, then in FIG. 13, step 805 the Member Access Server Computer sets the Member Session State, 502 to indicate successful authentication. Following step 805, the process returns at H to whichever superior process initiated the authentication request.

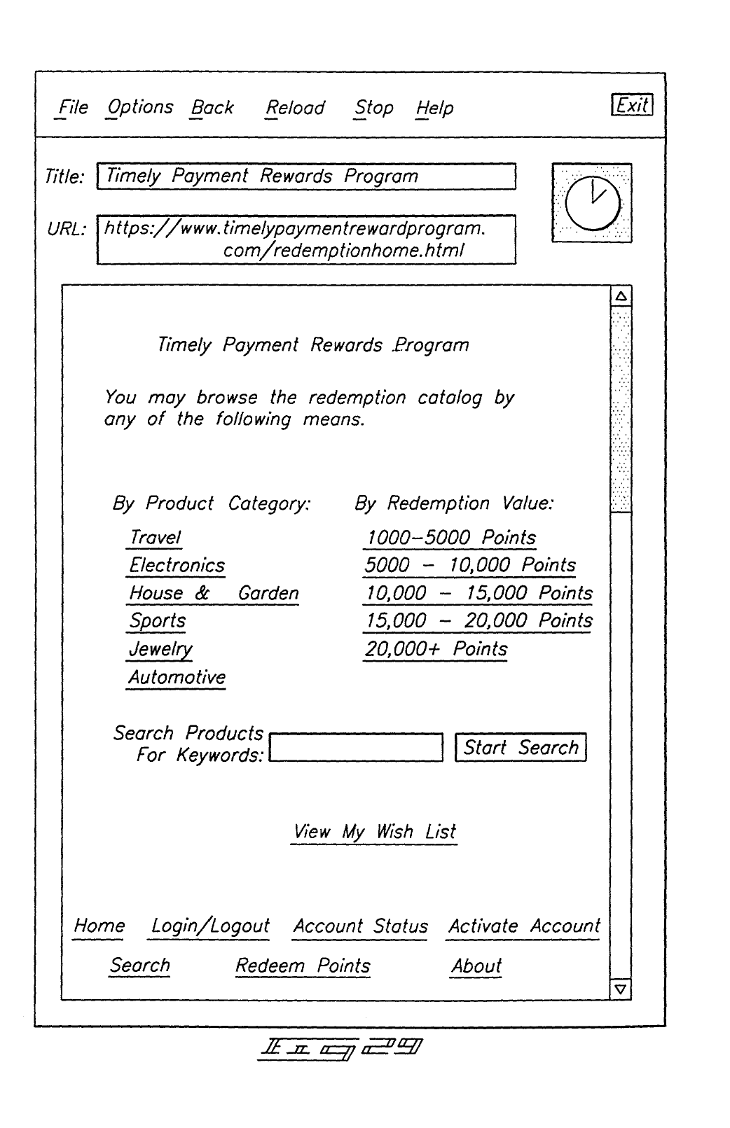

FIG. 14 depicts the operation of the rewards redemption process. The process begins at I, a reference to the superior process depicted in FIG. 9, the Program Navigation Menu. In FIG. 14, step 810, the Member Access Server Computer (FIG. 2, item 225) checks the Member's authentication status by reading the Member Session State, 502. Step 815 evaluates the result of step 810. If the result of 815 is negative, the process proceeds to G, a reference to the sub-process depicted in FIG. 13, Member Authentication. After completing this sub-process, the present process resumes at FIG. 14, H, whereupon, in FIG. 14, step 820, the process once again checks the authentication status. Step 825 evaluates the results of this test. If the result of step 825 is negative, then the process returns at J to the superior process depicted in FIG. 9. If the result of either authentication test at FIG. 14, step 815 or step 825 is positive, then in step 830, the Member Access Server Computer (FIG. 2, item 225) causes the Member Personal Computer (FIG. 2, item 215) to display the Redemption Program Home page, similar to that depicted in FIG. 29.

From the Redemption Program Home page, the Member may select any of five types of options: view products by category, view products by cost category, search products, view a personal wish list, or exit.

If the result of step 835 in FIG. 14 is positive, meaning that the Member has chosen to view a list of products belonging to a specific product category, then in step 840 the information about the products in the selected category is retrieved from the Redemption Catalog Database, 240, as indicated by reference Y. If the result of step 835 is negative, then the process proceeds to step 845.

If the result of step FIG. 14, 845 is positive, meaning that the Member has chosen to view a list of products belonging to a specific cost category, then in step 850 information is retrieved from the Redemption Catalog Database, 240 (as indicated by reference Y) about the products whose redemption costs, as measured in program Points, lie within the limits of the selected cost category. If the result of step 845 is negative, then the process proceeds to step 855.

If the result of FIG. 14, step 855 is positive, meaning that the Member has chosen to search the Redemption Catalog for products according to any of several criteria, including, for example, keywords or prices, then in step 860 information is retrieved from the Redemption Catalog Database, 240 (as indicated by reference Y) about the products that match the criteria specified by the Member. If the result of step 865 is negative, then the process proceeds to step 865.

If the result of FIG. 14, step 875 is positive, meaning that the Member has chosen to view a list of the products previously selected for inclusion on his or her Wish List, then in step 870, information is retrieved from the Member Account Database, 230 (as indicated by reference X) which is used in turn to retrieve information from the Redemption Catalog Database, 240 (as indicated by reference Y) about those products belonging to the Member's Wish List. If the result of step 865 is negative, then the process proceeds to step 875.

If the result of FIG. 14, step 875 is positive, meaning that the Member has chosen to exit the Redemption Program, then the process returns at J to the superior process depicted in FIG. 9, the Program Navigation Menu. If the result of step 875 is negative, the process repeats at step 830.

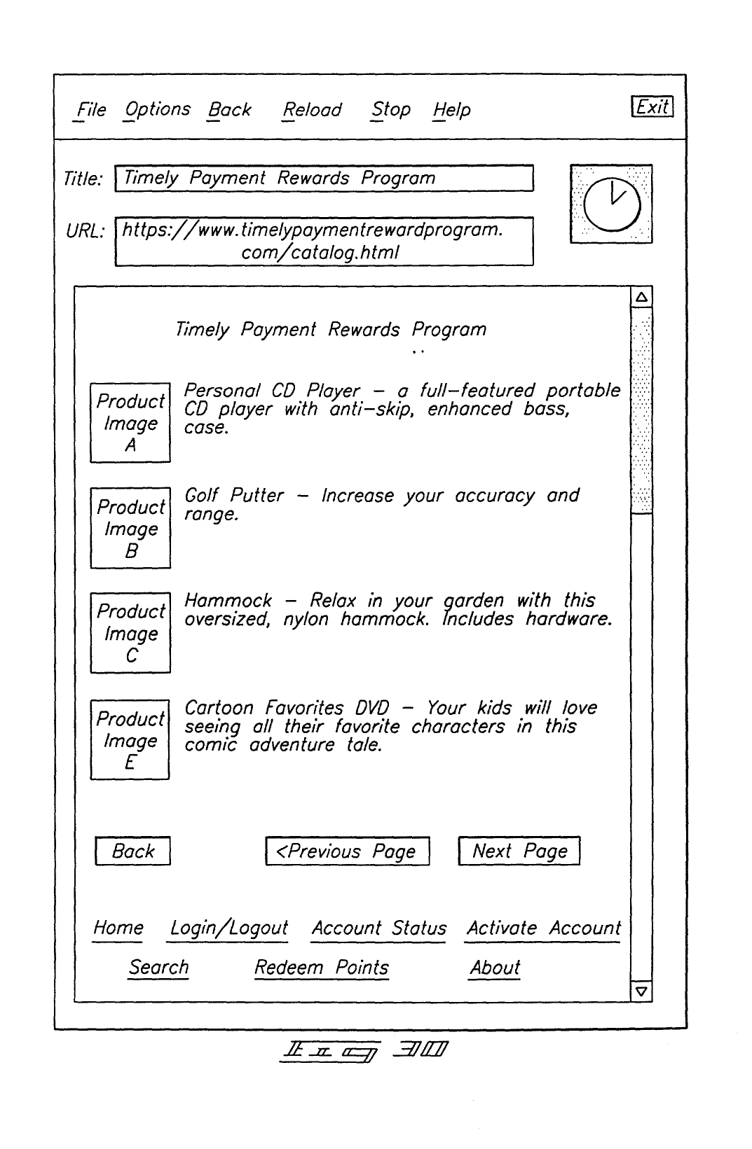

With further reference to FIG. 14, after retrieving and collating the appropriate product data in any of the steps 840, 850, 860, or 870, the Member Access Server Computer (FIG. 2, item 225) causes the Member Personal Computer (FIG. 2, item 215) in FIG. 14, step 880, to display the Products List page, similar to that depicted in FIG. 30.

In FIG. 14, step 885, the Member Access Server Computer (FIG. 2, item 225) determines whether the member has selected exit. If the result of step 885 is positive, the process returns to step 830. If the result of step 885 is negative, the process continues to step 890.

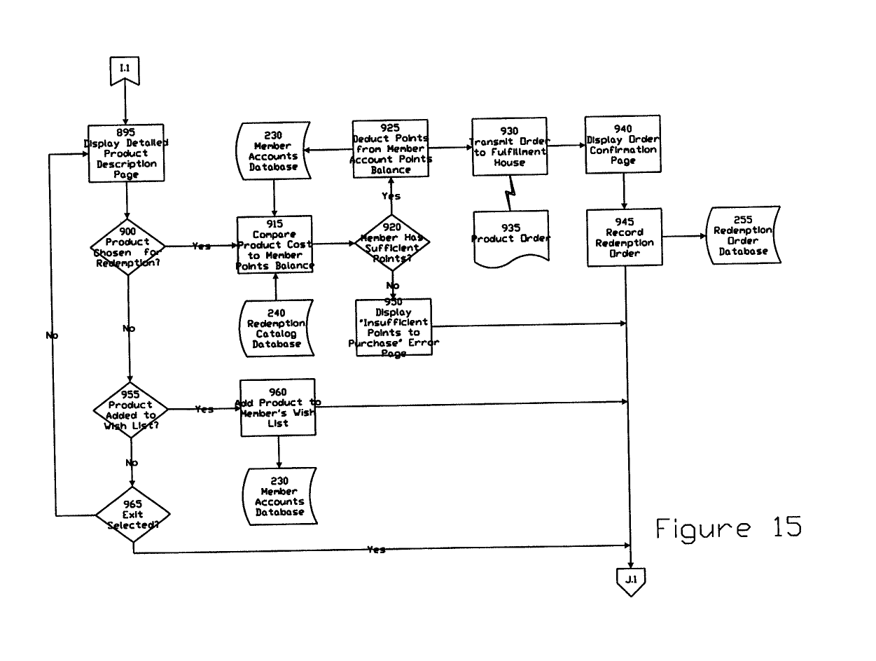

In FIG. 14, step 890, the Member Access Server Computer (FIG. 2, item 225) determines whether a product has been selected from the Product Listing page (FIG. 30). If the result is negative, the process repeats by returning to step 880 to await further member input. If the result is positive, the process proceeds to I.1, a reference to the sub-process depicted in FIG. 15. After completing the sub-process, the process depicted in FIG. 14 continues at J.1, and returns to FIG. 14, step 880 to await further member input.

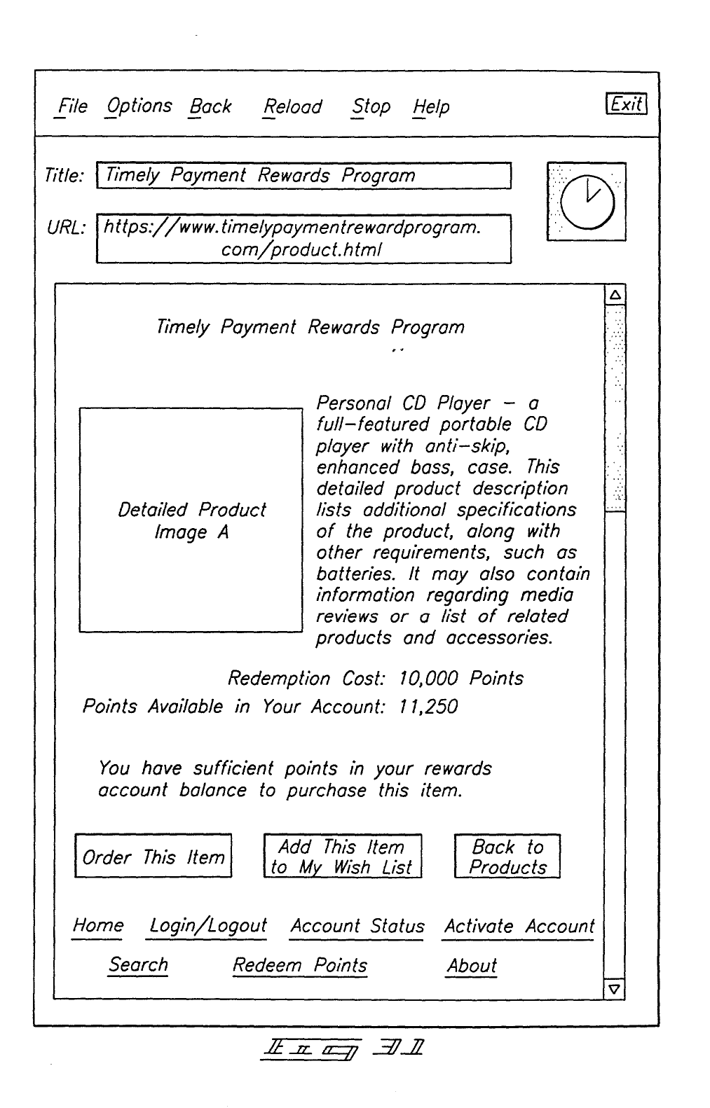

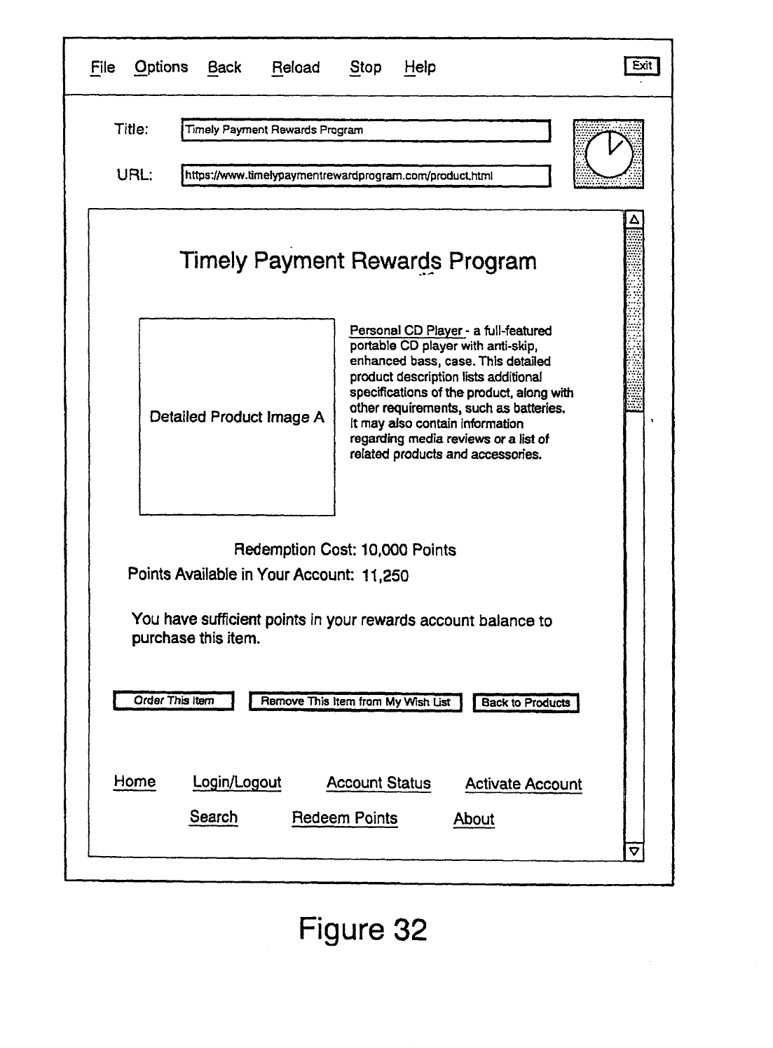

FIG. 15 depicts a process by which a Member may redeem accrued points for specific products in the Redemption Catalog, or may add those products to his or her Wish List for alter redemption. Upon invocation at I.1, a reference to the superior process depicted in FIG. 14, the Member Access Server Computer (FIG. 2, item 225) causes the Member Personal Computer (FIG. 2, item 215) to display the Detailed Product Description Page, similar to that depicted in FIG. 31. The Detailed Product page displays at least three specific options: (1) “Order This Item,” (2) “Add This Item to My Wish List,” or (2) “Back to Products.” If the member arrives at the Detailed Product page by from his or her Wish List, then the option to “Add This Item to My Wish List” will be replaced by the option to “Remove This Item from My Wish List,” as depicted in FIG. 32.

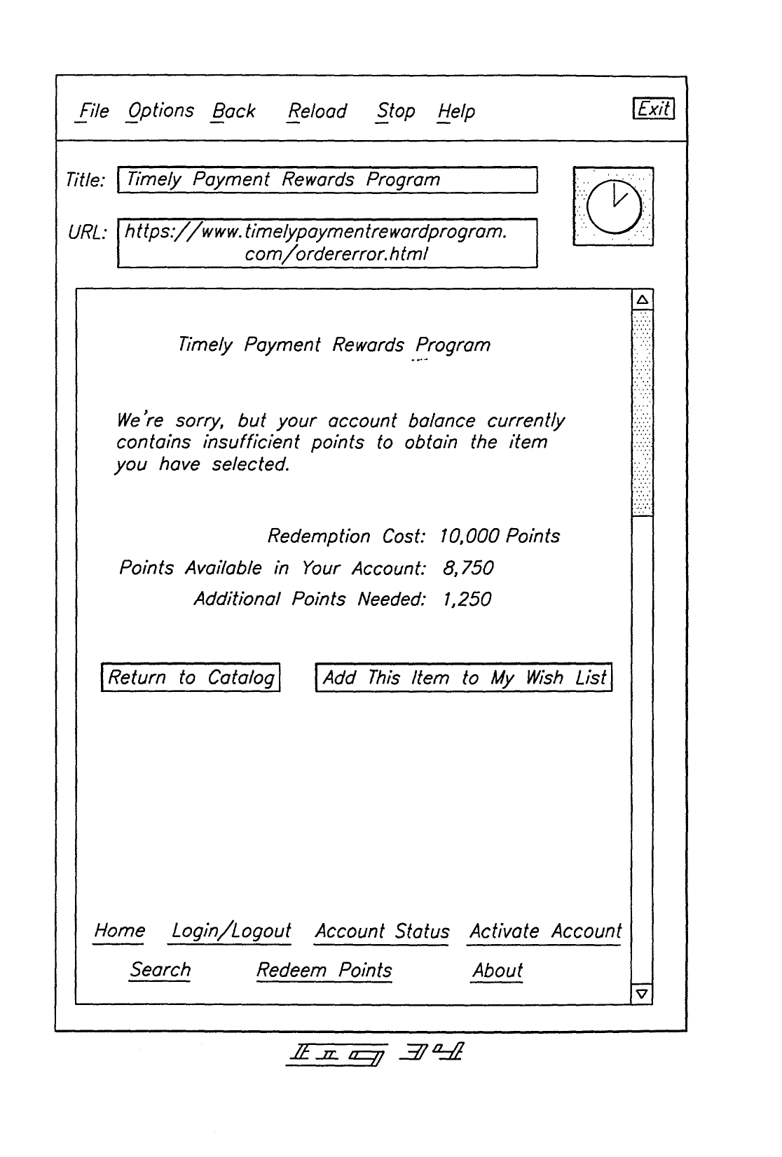

FIG. 15, Step 900 evaluates whether the Member has selected the option to order by redeeming his or her accumulated Points. If the result of step 900 is positive, then in step 915 the Member's Points balance is compared to the Points cost of the selected catalog item. In step 920, the process evaluates whether the Member possesses sufficient Points to redeem them for the item. If the result of step 920 is negative, the Member Access Server Computer causes the Member Personal Computer to display an error page indicating the additional number of Points needed to obtain the item, in a form similar to that depicted in FIG. 34. If the result of FIG. 15, step 920 is positive, then in step 925 the Member's account is updated in the Member Accounts Database, 230, by deducting the required points from the account's Points balance.

It should be noted that if the result of FIG. 15, step 920 is positive, meaning that the Member has sufficient points to complete the redemption, the selected redemption product may be automatically read into the following steps for processing. However, the Member may also be prompted to verify that this is the correct item for which he or she wishes to redeem his or her points, and to for additional information necessary to complete the order, such as color, size, etc.

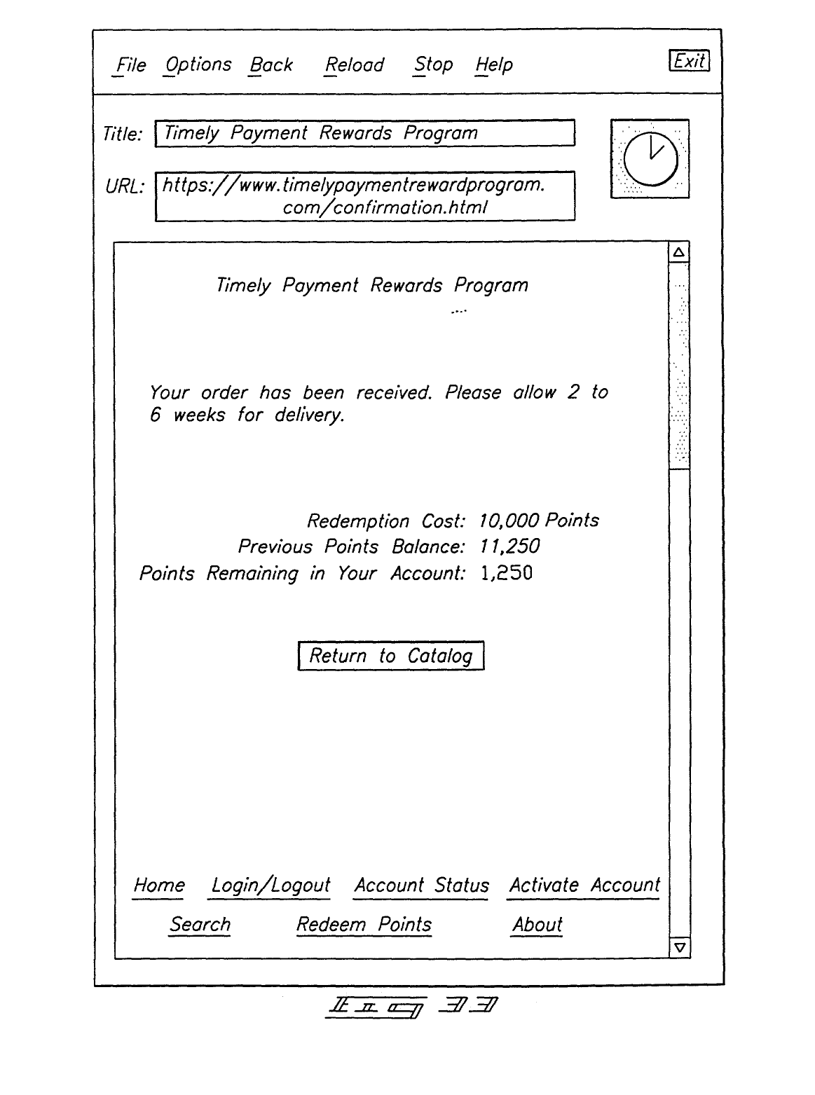

In FIG. 15, step 930, an order, 935, is transmitted to the product fulfillment house. In step 940, the Member Access Server Computer causes the Member Personal Computer to display an Order Confirmation Page, similar to that depicted in FIG. 33. In FIG. 15, step 945, the Redemption Order is recorded in the Redemption Order Database, 255, and the process returns to the superior process depicted in FIG. 14, as indicated in FIG. 15 by reference J.1.

If the result of FIG. 15, step 900, is negative, meaning that the member has not selected the product for redemption, then step 955 evaluates whether the member has selected the option to add the product to his or her Wish List. If the result of step 955 is positive, then in 960, the product is added to the Member's Wish List by updating the Member Accounts Database, 230. After completion of step 960, the process returns to the superior process depicted in FIG. 14, as indicated in FIG. 15 by reference J.1.

If the result of FIG. 15, step 955 is negative, meaning that the member has not selected the option to add the product to his or her Wish List, then step 965 evaluates whether the member has selected the exit option. If the result of step 965 is negative, then the process repeats at step 895. If the result of step 965 is positive, then the process returns to the superior process depicted in FIG. 14, as indicated in FIG. 15 by reference J.1.

In the description of the preferred embodiment, the term user or Member also refers to merchants, product manufacturers, award program administrators, and multiple other potential users or members. These particular users may be provided with a special access code. Upon entering the special code and associated password, any of these particular users may be provided with privileged access to the program, allowing them to make limited changes to the data. Thus, for example, a program administrator may gain privileged access to add or remove redemption products from the Redemption Catalog Database (FIG. 2, item 240). In addition, in the preferred embodiment a report is generated upon each privileged entry so that the changes made can be monitored.

Certain variations would be apparent to those skilled in the art, which variations are considered within the spirit and scope of the claimed invention.

As will be appreciated by those of reasonable skill in the art, there are numerous embodiments to this invention, and variations of elements and components which may be used, all within the scope of this invention.

One embodiment of this invention for example is a method for implementing an on-line incentive program for members who are making installment payments, said method comprising the steps of: providing an Internet webpage accessible to at least a member, via a computer system, for on-line interactive communications between said member and said Internet webpage; offering, on said Internet webpage, installment payment schedule information to said member; determining whether said member qualifies for one or more award points based on said member making one or more timely installment payment; calculating said award points according to a preprogrammed formula if said member qualifies for said award points; and issuing said award points to an account of the member if the member qualifies for said award points, wherein said award points are redeemable by the member for an award.

A further method embodiment for implementing an on-line incentive program for members who are making installment payments as recited above, said method further including the step of offering, on said Internet webpage, electronic installment payment capability to said member.

Another embodiment of a method for redeeming incentive awards in an on-line incentive program, may be the method of: implementing an on-line incentive program that issues award points to members who are making installment payments, wherein said award points are redeemable by said members for an award; implementing an Internet webpage accessible, via a computer system, to at least one member of said on-line incentive program for on-line interactive communications between said member and said Internet webpage; offering, accessible from or on said Internet webpage, at least one redeemable award available to said member for exchange of said award points; and permitting said member to initiate a process to receive said at least one redeemable award for exchange of said award points issued to said member through said on-line incentive program.

Another embodiment of this invention is a computer readable medium comprising a plurality of instructions, which when executed by a computer, causes the computer to perform the steps of: providing an Internet webpage accessible to at least one member, via a computer system, for on-line interactive communications between said member and said Internet webpage; offering, on said Internet webpage, installment payment schedule information to said member; determining whether said member qualifies for one or more award points based on said member making one or more timely installment payments; calculating said award points according to a pre-programmed formula if said member qualifies for said award points; and issuing said award points to an account of said member if said member qualifies for said award points, wherein said award points are redeemable by said member for an award. A further embodiment would be the foregoing plus the step of offering, on said Internet webpage, electronic installment payment capability to said member.

In yet another embodiment of the invention, a computer readable medium may be provided which comprises a plurality of instructions, which when executed by a computer, causes the computer to perform the steps of: implementing an online that issues award points to members wherein said award points are redeemable by said member for an award; providing an Internet webpage accessible to at least one member, via a computer system, for on-line interactive communications between said member and said Internet webpage; offering, on said Internet webpage, installment payment schedule information to said member; determining whether said member qualifies for one or more award points based on said member making one or more timely installment payments; calculating said award points according to a preprogrammed formula if said member qualifies for said award points; and issuing said award points to an account of said member if said member qualifies for said award points, wherein said award points are redeemable by said member for an award.

The invention may also be embodied in a computer system for implementing an on-line incentive program, said computer system comprising: software for offering at least one product for sale to at least one member via an Internet webpage, said Internet webpage being accessible to said member for online interactive communications between said member and said Internet webpage; and software for determining whether said member qualifies for one or more award points based on said member making one or more timely installment payments, for calculating said award points according to a preprogrammed formula if said member qualifies for said award points, and for issuing said award points to an account of said member if said member qualifies for said award points, wherein said award points are redeemable by said member for an award.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A method for implementing an on-line incentive program for members who are making installment payments, said method comprising the steps of:
providing an Internet webpage accessible to at least a member, via a computer system, for on-line interactive communications between said member and said Internet webpage;
offering, on said Internet webpage, installment payment schedule information to said member;
determining whether said member qualifies for one or more award points based on said member making one or more timely installment payment;
calculating said award points according to a preprogrammed formula if said member qualifies for said award points; and
issuing said award points to an account of the member if the member qualifies for said award points, wherein said award points are redeemable by the member for an award.

2. A method for implementing an on-line incentive program for members who are making installment payments as recited in claim 1, said method further comprising the step of offering, on said Internet webpage, electronic installment payment capability to said member.

3. A method for redeeming incentive awards in an on-line incentive program, said method comprising the steps of:
implementing an on-line incentive program that issues award points to members who are making installment payments, wherein said award points are redeemable by said members for an award;
implementing an Internet webpage accessible, via a computer system, to at least one member of said on-line incentive program for on-line interactive communications between said member and said Internet webpage;
offering, accessible from or on said Internet webpage, at least one redeemable award available to said member for exchange of said award points; and
permitting said member to initiate a process to receive said at least one redeemable award for exchange of said award points issued to said member through said on-line incentive program.

4. A computer readable medium comprising a plurality of instructions, which when executed by a computer, causes the computer to perform the steps of:
providing an Internet webpage accessible to at least one member, via a computer system, for on-line interactive communications between said member and said Internet webpage;
offering, on said Internet webpage, installment payment schedule information to said member;
determining whether said member qualifies for one or more award points based on said member making one or more timely installment payments;
calculating said award points according to a pre-programmed formula if said member qualifies for said award points; and
issuing said award points to an account of said member if said member qualifies for said award points, wherein said award points are redeemable by said member for an award.

5. A computer readable medium as recited in claim 4, and further comprising the step of offering, on said Internet webpage, electronic installment payment capability to said member.

6. A computer readable medium comprising a plurality of instructions, which when executed by a computer, causes the computer to perform the steps of:
implementing an on-line that issues award points to members wherein said award points are redeemable by said member for an award;
providing an Internet webpage accessible to at least one member, via a computer system, for on-line interactive communications between said member and said Internet webpage;
offering, on said Internet webpage, installment payment schedule information to said member;
determining whether said member qualifies for one or more award points based on said member making one or more timely installment payments;
calculating said award points according to a preprogrammed formula if said member qualifies for said award points; and
issuing said award points to an account of said member if said member qualifies for said award points, wherein said award points are redeemable by said member for an award.

7. A computer system for implementing an on-line incentive program, said computer system comprising:
software for offering at least one product for sale to at least one member via an Internet webpage, said Internet webpage being accessible to said member for on-line interactive communications between said member and said Internet webpage; and
software for determining whether said member qualifies for one or more award points based on said member making one or more timely installment payments, for calculating said award points according to a preprogrammed formula if said member qualifies for said award points, and for issuing said award points to an account of said member if said member qualifies for said award points, wherein said award points are redeemable by said member for an award.
